(19) United States
(12) Patent Application Publication
(10) Pub. No.: US 2002/0122410 A1
(43) Pub. Date: Sep. 5, 2002

(54) Method of wireless data exchange amongst devices of limited range

(75) Inventors: Vladimir Kulikov, Moscow (RU); Konstantin Davydow, Moscow (RU); Oleg Shiyanenko, Moscow (RU); Boris Luzqin, Mascow (RU)

Correspondence Address: SERGEY PLATONOV, 16-7 LOMONOSOVA STR., ZHUKOVSKY, MOSCOW REG., MOSCOW, 140180, RU

(73) Assignee: CYBIKO INC., BLOOMINGDALE, IL (US)

(21) Appl. No.: 09/683,745

(22) Filed: Feb. 11, 2002

Related U.S. Application Data
(60) Provisional application No. 60/268,515, filed on Feb. 13, 2001.

(51) Int. Cl. H04J 3/24

(52) U.S. Cl. 370/349; 370/389

(57) ABSTRACT

Proposed a method of wireless data exchange amongst ad-hoc mobile devices of limited range within a communications network, the network comprising a plurality of mobile units including a source mobile unit and a destination mobile unit and a plurality of wireless communication links wirelessly connecting together, the said method comprising—a special communicative protocol supporting a plurality of tasks in connection with ad-hoc network abilities (CYRF protocol),—a special communicative protocol supporting a plurality of tasks on global communications (GLOBAL MESSAGING TRANSPORT),—a special entertainment—, e-mail—and organizer type features, based on wireless ad-hoc networks″abilities gained by said protocols.

### BACKGROUND OF INVENTION

Fail Safe Filing System MethodThe method of increasing fault tolerance of a file system for carriers with a limited recording operation resource consists in making identical format for all blocks of the carrier reserved as accessible. Each block of the carrier is given a block occupation attribute to consider it either busy of free for recording; file identifier; logical number of the file block; and the data size in the block is thus defined. Meanwhile for the first block of the file the file name will be additionally included in its format. As the system launches it attributes to each set of the logical block numbers its corresponding virtual physical number from 0 to Nmax, where Nmax is the maximal number of the block dependent on the carrier capacity, and defines the blocks with the occupation status attribute, by which it finds their logical numbers and belonging to a particular file. In case of a failure of a block with a specific logical number to record the data, the system searches for another block free-for-recording and records data into the block, in which case the system marks the failed block with a damage attribute and gives the physical number of the failed block to the logical number of the block, in which the record was actually made.

Routing MethodThe present invention relates to a novel routing method specifically adapted for use with ad-hoc heterogeneous mobile networks and more particularly though not exclusively to a routing method where communications between source and destination mobile units is carried out across a conference size packet radio network of mobile units.

Status of the Prior Art Ad-hoc heterogeneous mobile networks have recently become important in the field of mobile communications particularly with respect to mobile computer supported collaborative work. An Ad-hoc heterogeneous mobile network comprises a plurality of mobile units each being able to communicate with its neighbouring mobile units which are a single hop away. In such a network, each mobile unit acts as a router forwarding packets of information from one mobile unit to another via any existing communication link between them.

Ad-hoc heterogeneous mobile networks differ from infra-structured wireless local area networks in that they do not have any access to base stations. Rather, in an ad-hoc heterogeneous mobile network, the mobile units have always to be able to communicate with each other over a wireless or wired media without any infra-structured network component support. Accordingly, one of the most important features of ‘any routing method or protocol for an ad-hoc mobile network, is the ability to adapt well to link changes, namely changes in the interconnectivity between mobile units due to mobile units’migrations. Ideally, mobile units should not spend most of their time updating and computing routes in sympathy with other mobile units’ movements. However, conventional distributed routing schemes attempt to maintain consistent routing information by performing periodic link and topology updates. These updates are undesirable because of the frequent link changes occurring in ad-hoc heterogeneous mobile networks, which can result in an enormous number of transmissions over the wireless and wired media to propagate and update routes. This is highly impractical, very, inefficient and results in low data throughput in an environment where bandwidth and battery power are scarce resources.

One of the earliest deployments of a regional-wide wireless data network was the ARPANET Packet Radio Network (PRN) by Kohn, Gronemeyer, Burchfiel and Kunzelman. As shown in FIG. 1, all components (repeaters R. terminals T and stations S) in a PRN can be mobile or certain components can remain fixed while others are moving. There are two approaches used in a PRN for routing and packet forwarding. In “point-to-point” routing, the station computes all the routing information and the decision is either distributed to the repeaters involved in the route or to the source. This scheme is only suitable for slow moving user terminals. However, in “broadcast routing”, each packet radiates away from the source with a wave-front-like propagation. Since no station needs to be present to compute routes, the destination address serves to identify the intended recipient. For fast moving user terminals, broadcast routing is preferred over point-to-point routing as it avoids the need to process rapidly changing routes.

In the connectionless approach to packet forwarding, some background operation is required to maintain up-to-date network topology and link information in each node. Accordingly, as network topology changes, the background routing traffic required in using the connectionless approach can be substantial. The connectionless approach is commonly associated with broadcast routing, where each packet carries sufficient routing information for it to arrive at the destination. However, in the connection-oriented approach, an explicit route establishment phase is required before data traffic can be transported. The connection-oriented approach is commonly associated with point-to-point routing, where each node in a route has a look up table for forwarding incoming packets to the respective out-going links. The disadvantage of the connection-oriented approach is that if the network topology changes, a route re-establishment phase is required.

Several ad-hoc mobile routing schemes have evolved over the past few years. Most of these schemes are based on either broadcast or point-to-point routing using either the connectionless or connection-oriented packed forwarding approach.

The “Layer Net” self-organizing protocol proposed by Bhatnagar and Robertazzi uses a connectionless packet forwarding approach. Broadcast routing is used for the initial network connectivity construction and the subsequent topology maintenance as a result of nodes' movements and link changes. Network topology updates have to be performed in sympathy with link changes and routes are not constructed based on demand. Accordingly, the overall signaling traffic can be quite substantial.

Cluster-based routing by Krishna, Chatterjee, Vaidya and Pradhan uses the broadcast routing and connectionless packet forwarding approach. Cluster-based routing relies on existing routing schemes such as link-state or distance-vector routing to derive network topology and link information. In addition, a clustering methodology is used to reduce the number of updates due to mobile units'migrations. Routes are constructed between all pairs of nodes and route maintenance is essentially cluster maintenance. The disadvantage of cluster-based routing is that the method is inefficient.

Source-initiated distributed routing by Corson and Ephremides uses a combination of point-to-point and broadcast routing using the connection-oriented packet forwarding approach. Here routes are initiated by the source and are constructed based on demand, and so this method forgoes the need to constantly propagate up-to-date routing information throughout the network. However, because alternate route information is used during route re-construction, problems associated with stale routes exist.

The Destination Sequence Distance-Vector routing scheme proposed by Perkins and Bhagwat is an enhancement of the existing distance-vector Bellman-Ford routing, so that ad-hoc mobile networking can be supported. Because each mobile unit has to periodically advertise its view of the network topology, this scheme is inefficient. Similar to cluster-based routing, the broadcast routing and connectionless packet forwarding approach is adopted.

Dynamic source routing for mobile networks by Johnson avoids periodic route advertisements because route caches are used to store source routes that a mobile unit has learnt over time. A combination of point-to-point and broadcast routing using the connection-oriented packet forwarding approach is used. Routes are source-initiated and discovered via a route discovery protocol. With source routing, the sender explicitly lists the route in each packet's header, so that the next-hop nodes are identified as the packet travels towards the destination. Cached route information is used and accurate updates of these route caches are essential, otherwise routing loops can occur. Since the sender has to be notified each time a route is truncated, the route maintenance phase does not support fast route reconstruction.

BroadCastingWireless communication systems, e.g. wireless LANs have a trend to loose some data packets transmitted for broadcast. There for such information should be send periodically.

CyLandiaCyLandia can be used as interractive computer game and minicomputer can be equiped with additional feature of sending pets in the mode of wareless net game session into game CyLandia used as application on the another minicomputer taking part in wareless game session. List of the users are currently playing in the CyLandia can be shown on the user display screen. Thus user can select desired game partner.

CyLandia concern to “CyLandia Distributed Artificial Life Simulator” game style.

The aim of the game is to help Cy-B to live long life, tending him every day. In the game you can earn money, give birth to small Cy-Bs and many others.

One human day corresponds to one game year that consists of four game days. For synchronizing the game time on all Cybiko computers it is used a special time meter (so-called trusted time) that is synchronized with the Eastern Time. The game simulates that it is going on even if your Cybiko computer is off. The hero of the game, Cy-B, passes five periods during his life: childhood, youth, maturity, old age and death.

The state of the game is saved periodically in the file of fixed size. This file is scrambled in order to avoid its cracking.

Cy-B can do many actions: eat, drink, wash, play on PC, watch TV, clean a flat, sleep, go in for sport, read, go to work, visit friends on other Cybiko computers, communicate with other Cy-Bs. You should help him to learn these basic skills. Finally, with a good training, your Cy-B will develop his skills and will do everything himself. Cy-B will learn faster if you praise him for the right actions, when the player increases points. Cy-B can talkto you, including complaining or delighting with you. He emotionally reacts on events happened with him and around him.

Your Cy-B has genetic inclination(genotype) inherited from his parents. It means that if his parents were intelligent, then Cy-B will be likely intelligent too. But anyway you have to help him to learn.

The game starts with a definite amount of CyBucks. This is money that you may spend for things, foods, purchasing shares or for some actions. Shares of certain companies give definite discount in buying products of the same field, also they bring annual dividends. You can increase your capital trading with other Cybiko computers. All property as well as cash (capital) are taxed annually. Player should learn some economic basics.

You personage can visit Cy-Bs on other devices with CyLandia, get friends there, get married and bear children. Each Cy-B has a pocket, to which he can put any things or money and visit friends with these things in the pocket. At an early age Cy-B gets child support. In future he can get a job that corresponds his skills (strength, intellect, sociability) that are developed during the game. While Cy-B is unemployed, he gets dole.

The yearly newspaper is issued in the game, where all CyLandia events affecting economics and personage”s desires are described. The process of getting ajob is also realized through the newspaper. The newspaper is refreshed from the Cybiko web site via the communication program CyberLoad. The trusted timesynchronization guarantees, that all new issues will reach all Cybiko computers simultaneously.

If you treat your Cy-B badly, he can get ill and even become virus infected. In the last case infected Cy-B can infect another healthy Cy-B.

The game keeps the log of all economic events that happened within the last two game days. For instance, how much food and other things were used, sold, bought, presented or gone into the pocket. The balance for the previous year is struck.

### SUMMARY OF INVENTION

Fail Safe File SystemA method for increasing fault tolerance of a file system for carriers with a limited recording operation resource and a protected file system for carriers with a limited recording operation resourceThe invention belongs to electrical technology. The method of increasing fault tolerance of a file system for carriers with a limited recording operation resource consists in making identical format for all blocks of the carrier reserved as accessible. Each block of the carrier is given a block occupation attribute to consider it either busy of free for recording; file identifier; logical number of the file block; and the data size in the block is thus defined. Meanwhile for the first block of the file the file name will be additionally included in its format. As the system launches it attributes to each set of the logical block numbers its corresponding virtual physical number from 0 to Nmax , where Nmax is the maximal number of the block dependent on the carrier capacity, and defines the blocks with the occupation status attribute, by which it finds their logical numbers and belonging to a particular file. In case of a failure of a block with a specific logical number to record the data, the system searches for another block free-for-recording and records data into the block, in which case the system marks the failed block with a damage attribute and gives the physical number of the failed block to the logical number of the block, in which the record was actually made.

CyLandiaCyLandia can be used as interactive computer game and minicomputer can be equiped with additional feature of sending pets in the mode of wireless net game session into game CyLandia used as application on the another minicomputer taking part in wireless game session.

CyLandia relates to “CyLandia Distributed Artificial Life Simulator” game style.

The aim of the game is to help Cy-B to live long life, tending him every day. In the game you can earn money, give birth to small Cy-Bs and many others.

One human day corresponds to one game year that consists of four game days. For synchronizing the game time on all Cybiko computers it is used a special time meter (so-called trusted time) that is synchronized with the Eastern Time. The game simulates that it is going on even if your Cybiko computer is off. The hero of the game, Cy-B, passes five periods during his life: childhood, youth, maturity, old age and death.

The state of the game is saved periodically in the file of fixed size. This file is scrambled in order to avoid its cracking.

Cy-B can do many actions: eat, drink, wash, play on PC, watch TV, clean a flat, sleep, go in for sport, read, go to work, visit friends on other Cybiko computers, communicate with other Cy-Bs. You should help him to learn these basic skills. Finally, with a good training, your Cy-B will develop his skills and will do everything himself. Cy-B will learn faster if you praise him for the right actions, when the player increases points. Cy-B can talk to you, including complaining or delighting with you. He emotionally reacts on events happened with him and around him.

Your Cy-B has genetic inclination(genotype) inherited from his parents. It means that if his parents were intelligent, then Cy-B will be likely intelligent too. But anyway you have to help him to learn.

The game starts with a definite amount of CyBucks. This is money that you may spend for things, foods, purchasing shares or for some actions. Shares of certain companies give definite discount in buying products of the same field, also they bring annual dividends. You can increase your capital trading with other Cybiko computers. All property as well as cash (capital) are taxed annually. Player should learn some economic basics.

You personage can visit Cy-Bs on other devices with CyLandia, get friends there, get married and bear children. Each Cy-B has a pocket, to which he can put any things or money and visit friends with these things in the pocket. At an early age Cy-B gets child support. In future he can get ajob that corresponds his skills (strength, intellect, sociability) that are developed during the game. While Cy-B is unemployed, he gets dole.

The yearly newspaper is issued in the game, where all CyLandia events affecting economics and personage”s desires are described. The process of getting ajob is also realized through the newspaper. The newspaper is refreshed from the Cybiko web site via the communication program CyberLoad. The trusted timesynchronization guarantees, that all new issues will reach all Cybiko computers simultaneously.

If you treat your Cy-B badly, he can get ill and even become virus infected. In the last case infected Cy-B can infect another healthy Cy-B.

The game keeps the log of all economic events that happened within the last two game days. For instance, how much food and other things were used, sold, bought, presented or gone into the pocket. The balance for the previous year is struck.

Routing Methodin view of the foregoing, the main object of this invention is to provide an improved routing method that provides efficient and high throughput communication between mobile units in an ad-hoc mobile network and which can deal effectively and efficiently with mobile units’migrations that effect the validity of routes through the mobile network.

Another object of the invention is to provide a routing method which avoids network congestion due to unfair burdening of a particular mobile unit to support many routes and to perform many information relaying functions.

Yet another object of the present invention is to provide a routing method which is able efficiently to handle concurrent movement of a plurality of mobile units in an ad-hoc mobile network.

Still another object of the present invention is to provide a routing method which is able readily to incorporate new mobile units into the ad-hoc network without requiring vast amounts of information about the new mobile unit.

A still further object of the invention is to provide a routing method which avoids packet duplicates, stale routes, loops and deadlock, but does this efficiently without requiring vast amounts of memory, bandwidth or power.

Briefly stated, these objects are attained in a routing method in which the stability of routes through an ad-hoc mobile communications network is measured using an associativity characteristic and selection of a particular route for transmission of information is based on that particular route's stability.

The associativity characteristic, which is simply a measure of the stability of a particular link between neighbouring mobile units, is measured by each mobile unit periodically transmitting and receiving identifier beacons (ticks) and updating the status of the corresponding links. The greater the number of ticks associated with a given link, the greater its stability or longevity.

More particularly, according to one aspect of the present invention there is provided a routing method for supporting ad-hoc mobile communications within a communications network, the network comprising a plurality of mobile units including a source mobile unit and a destination mobile unit and a plurality of communication links connecting together said plurality of mobile units, said method comprising: periodically transmitting and receiving identifier signals via said communication links between neighboring mobile units measuring the stability of said communication links between neighboring mobile units in accordance with the number of identifier signals received via said communication links selecting a communications route through the network from the source mobile unit to the destination mobile unit based on the stability of said communications links; and transmitting an information signal from said source mobile unit across said network via said selected communications route to said destination mobile unit.

In an embodiment of the present invention, associativity tables are provided at each mobile unit, each associativity table storing the stability for each of the communications links of the particular mobile unit. In addition, the forwarding delay associated with each communication link is provided at each mobile unit. Accordingly, the stability and transmission delay information associated with each communications link can be accessed and collated to determine the most viable route through the communications network.

Each mobile unit preferably comprises a routing table which is configurable to set a route for passing information signals through the mobile unit from one of its neighbours to others of its neighbours. The routing tables advantageously enable the mobile units to be arranged to support a plurality of routes through the network between various source and destination mobile units. In addition, each mobile unit preferably has the ability to store route relaying load information regarding the total number of selected routes supported by the mobile unit. Accordingly, the route selection procedure can consider the route relaying load information and avoid the selection of a route that would unfairly burden a particular mobile unit.

Seen tables may also be provided at each mobile unit. Each seen table records identifier data regarding information signals which have already passed through the mobile unit. The seen tables can then be used to discard information signals that have previously passed through the mobile unit. In the situation where the information signal is provided in data packets, provision of seen tables can avoid duplicate packets from being transmitted around the network.

The routing method preferably comprises providing a data flow acknowledgement mechanism comprising active and passive acknowledgements. The passive acknowledgement comprises receiving at a mobile unit an information signal previously sent by the mobile unit to one of its neighboring mobile units and which has been retransmitted back thereby. The active acknowledgement occurs when an information signal has reached its destination and retransmission of that signal would not occur passively. In this case, that signal is retransmitted actively by the destination mobile unit. Furthermore, the data flow acknowledgement preferably includes retransmitting the previously sent signal from the mobile unit to the neighboring mobile unit if a passive or active acknowledgement is not received within a predetermined time-out period.

The present invention also provides a routing protocol for supporting ad-hoc mobile communications within a communications network, the network comprising a plurality of mobile units, and a plurality of communication links connecting together said mobile units, said protocol comprising: a procedure for measuring the stability of the communications links between neighboring mobile units in accordance with the number of identifier signals received via said plurality of communication links by periodically transmitting and receiving said identifier signals via said plurality of communication links; a procedure for selecting a communications route through the network based on the stability of said communications links; and a procedure for restoring a selected communications route which has been invalidated due to movement of a mobile unit previously supporting the selected route, the restoring procedure establishing a new route through the network based on the existing stability between mobile units.

According to a further aspect of the present invention there is provided an ad-hoc mobile communications network for supporting mobile communications, said network comprising: a plurality of mobile units including a source mobile unit which desires to transmit information and a destination mobile unit to which said information is to be sent; a plurality of wireless communications links connecting together said plurality of mobile units; and a control algorithm implemented by said plurality of mobile units for establishing and maintaining a communications route from the source mobile unit to the destination mobile unit based on the stability of the communications links therebetween, the stability being determined by periodically transmitting and receiving identifier signals via said communication links and measuring the number of identifier signals received via said communication links.

CyberLoad features: 1) Transferring files and technical data between devices connected to a PC via RS232 port and the web site. CyberLoad displays a set of applications on the web site and on a device connected; users can choose applications and download them directly to the device. The list of available applications is created on the web-site (this depends on operating system version which is running on the device.)File transferring is performed using HTTP protocol.

2) Uploading files from a device connected to the web site. Every time a device is connected, a file that contains statistical data about application launching is uploaded to the web site. This file is called statistics file. It contains the number of times each application was started, and the best game scores. These results are used for estimation of application popularity.

3) Information about the best game scores can be digitally signed, thus confirming that the file was uploaded from a certain device. This feature allows conducting game contests. Best scores and ratings are shown on the web site, the information updating every time new results are received.

File uploading is performed using HTTP protocol.

4) Sending/receiving e-mail. As a device is connected, CyberLoad checks the device″s mailbox for unsent messages. These messages are sent via a mail server on the web site. Then CyberLoad checks the mail server for new e-mail messages for the device connected and downloads them to the device”s mailbox.

5) Synchronization with a mailbox. Content of device”s mailbox is synchronized with content of another mailbox, which is located on the web site”s mail server.

6) Transferring files between a PC and a device connected.

7) Updating operating system on the device connected. A new operating system is installed directly from the web site.

8) Task and contact synchronization between Microsoft Outlook and tasks/contacts on a device.

### BRIEF DESCRIPTION OF DRAWINGS

For a better understanding of the invention as well as other objects and further features thereof, reference is made to the following detailed description to be read in conjunction with the accompanying drawings, wherein:

FIG. 1 is a schematic diagram showing the prior art arrangement of a Packet Radio Network;

FIG. 2 is a graphical representation showing how the general property of associativity of a mobile unit with its neighbors’varies with time and space;

FIG. 3 is a schematic diagram showing the state of interdependent associativity found in mobile ad-hoc networks;

FIG. 4 is a schematic diagram showing how the merging of two communication sub-nets forms a larger communication network;

FIG. 5a is a schematic diagram showing how the associativity metric is utilised during a route discovery procedure of an embodiment of the present invention;

FIG. 5b is a flow diagram showing the steps involved in carrying out the route discovery procedure at the source node in the embodiment of the present invention;

FIG. 6a is a block diagram showing the format of a BQ control packet used in the embodiment of the present invention;

FIG. 6b is a flow diagram showing the steps involved in the route discovery procedure at the destination node of the embodiment of the present invention;

FIG. 6c is a block diagram showing the format of a REPLY control packet used in the embodiment of the present invention.

FIGS. 7a and 7b are schematic diagrams showing how interruptions in a REPLY packet propagation route are dealt with in the embodiment of the present invention;

FIGS. 8a, 8b and 8c are schematic network diagrams respectively showing how a Route Reconstruction Phase of the embodiment of the present invention operates when a source, destination and intermediate mobile unit migrate;

FIG. 8d is a flow diagram showing the steps involved in the Route Reconstruction Phase of the embodiment of the present invention when an active intermediate node or the destination node move out of range;

FIGS. 9a and 9b are block diagrams showing the respective formats in an RN control packet, an LQ control packet and an RD control packet used in the embodiment of the present invention;

FIG. 10 is a schematic diagram showing how the BQ seen table entry is erased in the embodiment of the present invention;

FIG. 11 is a flow diagram showing how packet retransmission is handled in the embodiment of the present invention; and

FIG. 12 is a schematic diagram showing the application of the associativity principle to the task of network resource adaptation in a base station wireless local area network.

FIG. 13 is a schematic diagram showing the main idea of the entitled method.

FIG. 14-16 are a schematic diagrams illustrating GLOBAL MESSAGING TRANSPORT method.

FIG. 17 is a schematic diagram interface of address/phone book feature as an example.

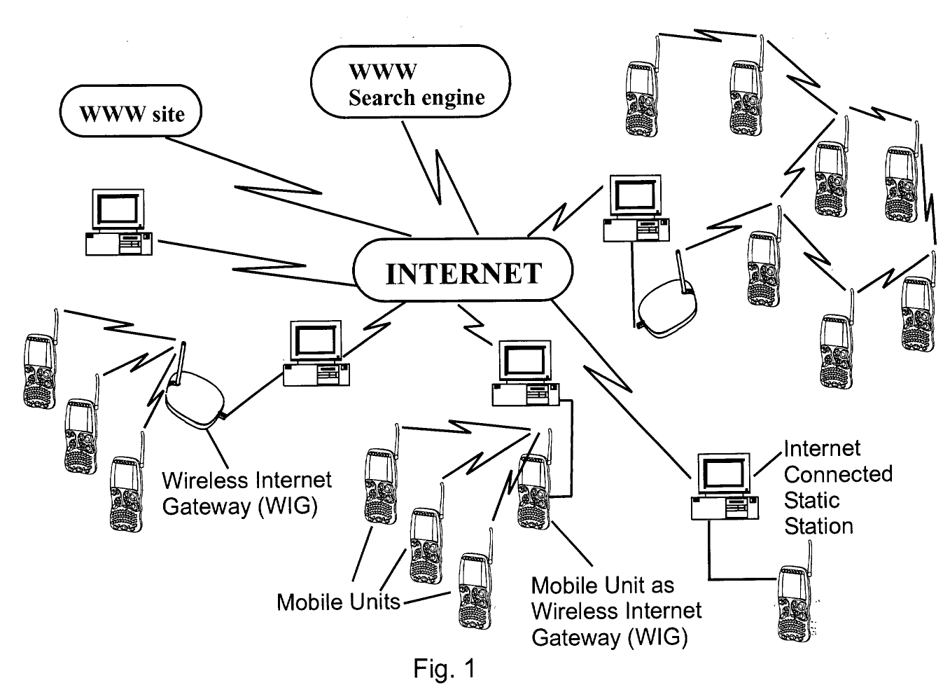

### DETAILED DESCRIPTION

A method of wireless data exchange amongst ad-hoc mobile devices of limited range within a communications network, the network comprising a plurality of mobile units including a source mobile unit and a destination mobile unit and a plurality of wireless communication links wirelessly connecting together, the said method comprising—a special communicative protocol supporting a plurality of tasks in connection with ad-hoc network abilities (hereinafter CYRF protocol) (for the best fit)—a special communicative protocol supporting a plurality of tasks on global communications (GLOBAL MESSAGING TRANSPORT) (hereinafter GMT).

a special entertainment—, e-mail—and organizer type features, based on wireless ad-hoc networks” abilities gained by said protocols,the said CYRF communicative protocol further comprising—a routing method for providing data exchange among devices in network,—a frequency division multiple access method,—an registration data broadcasting method,—RF output power control method,—fail-safe file system.

The said GLOBAL MESSAGING TRANSPORT (GMT) further comprising—special interfaces for data transfer amongst mobile devices and to/from global network.

The said special entertainment—, e-mail—and organizer type features further comprising-Friend Finder,-Wireless E-mail,-Wireless Chat,-Address/Phone Book,-EZ Loader and Cyber Load.

FIG. 13 shows the main idea of the entitled method.

Routing MethodHereinafter is described a method and protocol for supporting ad-hoc mobile computing within a radio communications network embodying the present invention. The communications network comprises a plurality of mobile units including a source mobile unit and a destination mobile unit, and a plurality of radio communications links connecting together the mobile units. However, before describing the above embodiment in detail, it is important to understand the principles behind the associativity characteristic and how it can be used in the routing method of the present embodiment.

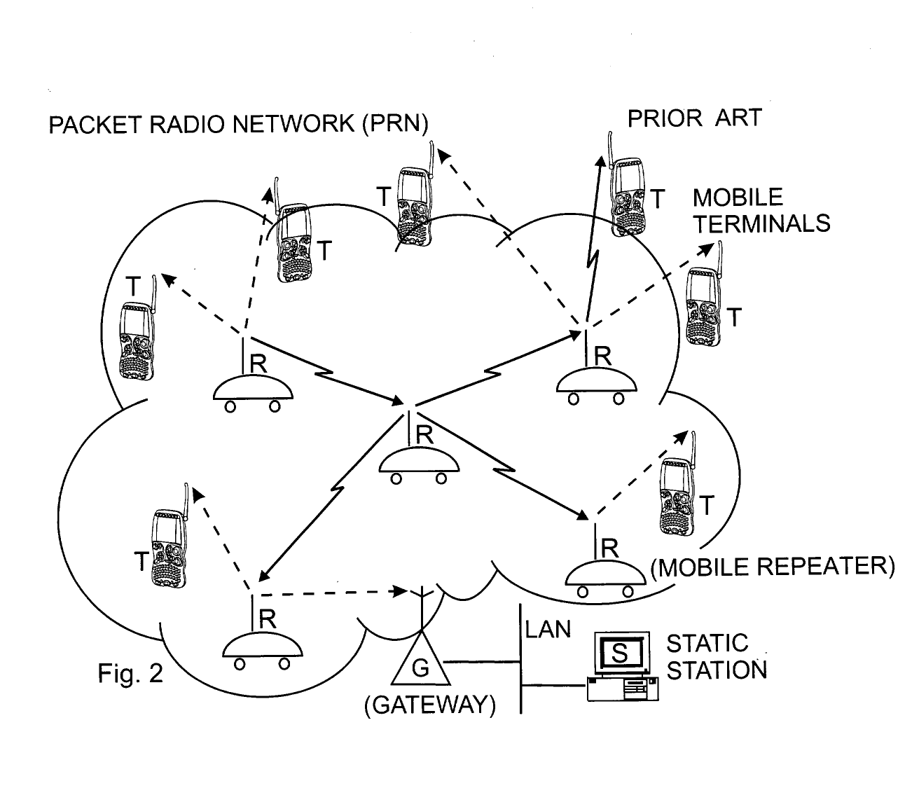

Referring now to FIG. 2, the associativity characteristic is measured by each mobile unit 2 periodically transmitting and receiving identifier beacons (ticks) via the mobile unit's data-link layer protocol and updating the status of its corresponding links. The greater the number of ticks associated with a given link, the greater its stability. A mobile unit's 2 association with its neighbours 4 changes as it is migrating and its transit period 6 can be identified by the associativity ticks. The migration is such that after this unstable period 6, there exists a period of stability 8, where the mobile unit 2 will spend some dormant time within a wireless cell 10 before it starts to move again causing link changes with the mobile unit—s neighbours 4. The threshold where the associativity transitions take place is defined by A.sub.threshold 12, as shown in FIG. 2.

In a scenario where an ad-hoc Wireless Local Area Network has a wireless cell size of 10 m with a mobile unit's minimum migration speed of 2 m/s and a beacon transmission interval of a second, the maximum possible number of associativity ticks of the migrating mobile unit 2 with its neighbours 4 is five. Likewise, the neighboring mobile units 4 will also record associativity ticks of no more than five. This value is the A.sub.threshold 12 and any number of associativity ticks greater than this threshold 12 implies periods 8 of association stability.

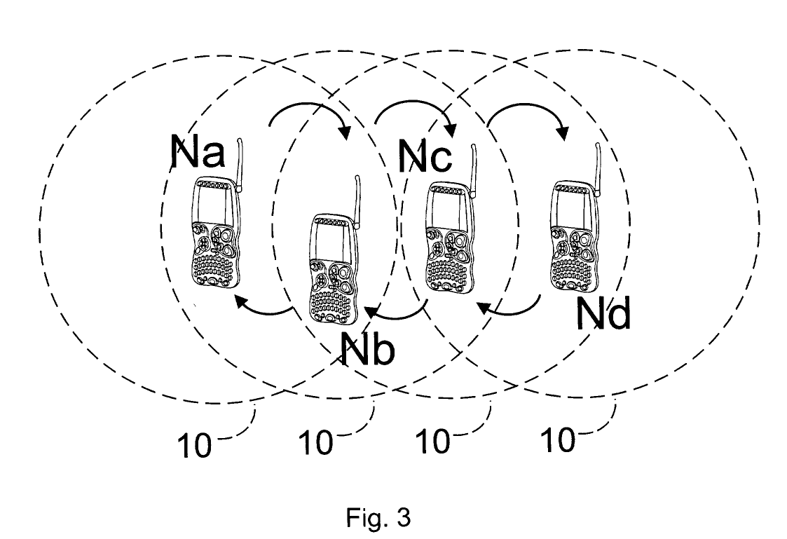

A mobile unit 2 is said to exhibit a high state of mobility when it has a low number of associativity ticks with its neighbors 4. On the other hand, if a high number of associativity ticks are observed, the mobile unit 2 is in the stable state 8 and this is the ideal point to select the mobile unit 2 to perform ad-hoc routing. Consequently, if all the mobile units 2 in a route have a high number of associativity ticks, an inter-dependent phenomenon arises where “my” degree of associativity will be high if “you” do not move out of reachability (i.e., a symmetric mutual-dependent property) and are in stable state, as illustrated in FIG. 3. The number of associativity ticks are reset when the neighbours 4 or the mobile unit 2 itself moves out of proximity, not when the communication session is completed and the route made invalid.

Every ad-hoc mobile network comprises a source mobile unit (source node) which desires to transmit information across the network, a destination mobile unit (destination node) which is the intended recipient of the information, and intermediate mobile units (intermediate nodes) which are configurable to relay the information between the source node and the destination node. For the sake of clarity, hereinafter the direction from the source node to the destination node will be referred to as downstream and the direction from the destination node to the source node as upstream. Movements of any of these mobile units (source, destination or intermediate nodes) can affect the validity of a selected communication route directly.

A source node in a route has a downstream link and when it moves out of its downstream neighbor's radio coverage range, the existing route will immediately become invalid. Hence, all the downstream nodes may have to be informed so as to erase their invalid route entries. Likewise when the destination node moves out of the radio coverage range of its upstream neighbour, the route becomes invalid. However, unlike the earlier case, the upstream nodes will have to be informed so as to erase their invalid route entries. In addition, any movements by one of the intermediate nodes supporting an existing route may cause the route to become invalid. In reality, concurrent moves by source, destination and intermediate nodes exist and require multiple responses by the routing protocol. All these nodes' movements cause many conventional distributed routing protocols to respond in sympathy with the link changes, in order to update all the remaining nodes within the network so that consistent routing information can be maintained. This involves broadcasting over the wireless medium which disadvantageously results in wasteful bandwidth and an increase in the overall network control traffic. However, use of the associativity characteristic at each mobile unit automatically updates routing information thereby avoiding this prior art disadvantage.

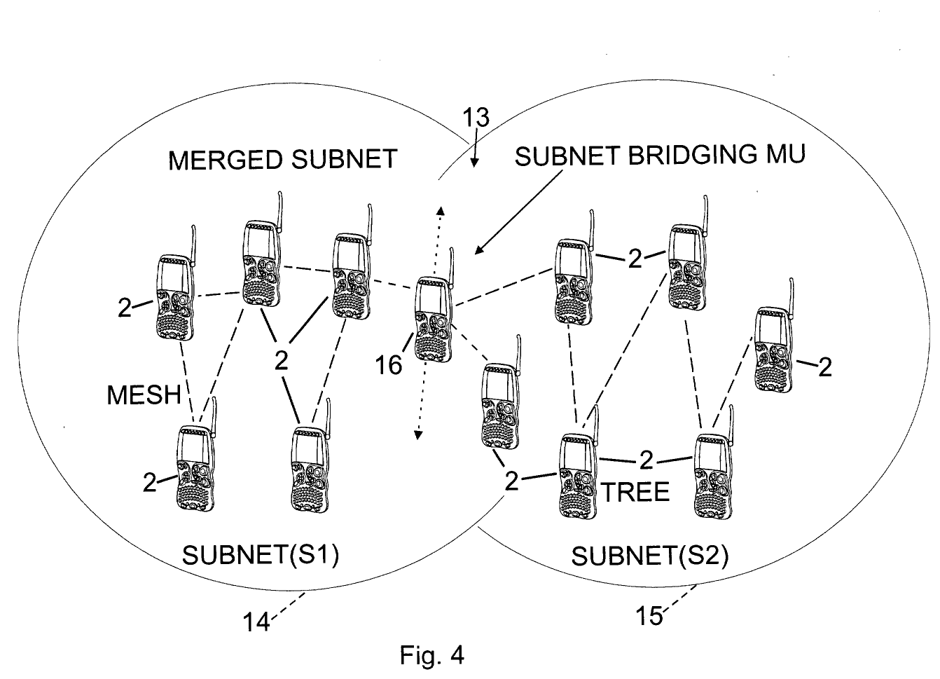

Referring to FIG. 4, there is shown a merged subnet 13 of mobile units 2. The merged subnet 13 comprises two subnets 14,15 linked by a subnet bridging mobile unit 16. Moves by a mobile unit 16 which is performing subnet-bridging function between two mobile subnets 14,15 can fragment the merged mobile subnet 13 into smaller subnets 14,15. The property of a mobile subnet states that if both the source node and destination node are part of the same subnet, a route or routes should exist unless the subnet is partitioned by some subnet—bridging mobile units 16. On the other hand, moves by certain mobile units can also result in subnets 14, 15 merging, giving rise to bigger subnets 13 as is illustrated in FIG. 4. When the mobile subnets 14, 15 merge to form bigger subnets 13, the routing protocol may typically accept the new subnet 13 by updating all the nodes' routing tables but this is very inefficient. However, use of the associativity characteristic is much more efficient because it updates only the affected mobile units' associativity tables, which is already an inherent part of the mobile units' radio data-link layer functions. Likewise, this applies to partitioning subnets.

From an application perspective, mobile subnets can be used to support nomadic collaborative computing, and the collaboration partners can grow in size when two collaborating groups join or when new mobile users join by coming into range.

Turning now to the embodiment of the present invention, the method comprises measuring the stability of the communications links between neighboring mobile units using the associativity based characteristic and selecting a communications route through the network from the source mobile unit to the destination mobile unit based on the stability of the communications links. Use of the associativity characteristic also enables the routing method to deal effectively with route invalidation caused by mobile unit migrations.

The method of the present embodiment is hereinafter referred to as Dynamic Routing by Request (DRR). DRR is a compromise between broadcast and point-to-point routing and uses the previously mentioned connection—oriented packet forwarding approach. DRR only maintains routes for source mobile units that actually desire routes. However, DRR does not employ route reconstruction based on alternative route information stored in intermediate nodes, which advantageously avoids stale routes. In addition, routing decisions are performed at the destination mobile unit and only the best route will be selected and used while all other possible routes remain passive, thereby avoiding packet duplicates. Furthermore, the selected route tends to be more long-lived due to the property of associativity.

The DRR protocol comprises three different phases, namely a Route Discovery phase, a Route Reconstruction (RRC) phase and a Route Deletion phase.

Initially, when a source node desires a route, the route discovery phase is invoked. When a link of an established route changes due to source node, destination node, intermediate node or subnet-bridging mobile units migration, the RRC phase is invoked. When the source node no longer desires the route, the route deletion phase is initiated.

The route discovery phase allows an approximation of the data throughput associated with the selected route to be computed. This is achieved through the knowledge of associativity ticks of neighbours in the route and a relaying load of each node supporting the route a parameter provided at each node in the network. The route discovery phase consists of a broadcast query (BQ) and await reply (REPLY) cycle.

BQ-REPLY cycle Initially, all nodes except those of the destination node's neighbours have no routes to the destination node. A node desiring a route to the destination node broadcasts a BQ packet, which is propagated throughout the ad-hoc mobile network in search of mobile units which have a route to the destination node. A sequence number (SEQ NO.) is used to uniquely identify each BQ packet and no BQ packet is broadcast more than once.

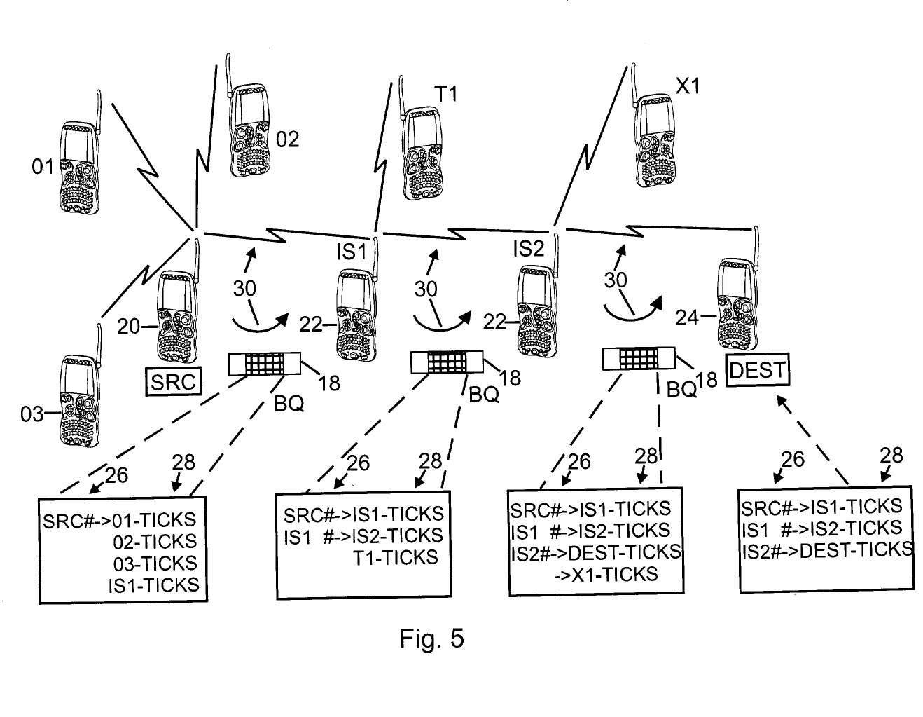

Referring now to FIG. 5a, once the BQ packet 18 has been broadcast by the source node 20, all neighboring nodes 01, 02, 03, IS1 that receive the packet 18 check if they have previously processed the BQ packet 18. If affirmative, the BQ packet 18 is discarded, otherwise the neighboring node 01, 02, 03, IS1 checks if it is the destination node 24. If it is not the destination node 24, the neighboring node 01, 02, 03, IS1 appends its mobile unit address 26 at the intermediate node identification (ID) field of the BQ packet 18 and broadcasts it to its neighbours (if it has any). The number of associativity ticks 28 with its neighbours will also be appended to the BQ packet 18 along with its route relaying load and forwarding delay information.

The retransmissions from the neighboring nodes 01, 02, 03, IS1 all return back to the source node 20 where they are discarded. However, one of the neighboring nodes IS1 which is called an intermediate node 22, transmits the BQ packet 18 to its neighboring nodes T1, IS2 where the above described procedure is repeated.

The next succeeding intermediate node 22, IS2 will then erase its upstream node's neighbours' associativity ticks entries 28 and retain only those concerned with itself and its upstream node. In addition, because of the association ticks 28 symmetry between nodes, the associativity ticks 28 received from the upstream node can be checked for validity. The above described route discovery procedure carried out at the source node is illustrated in the flow chart of FIG. 5b.

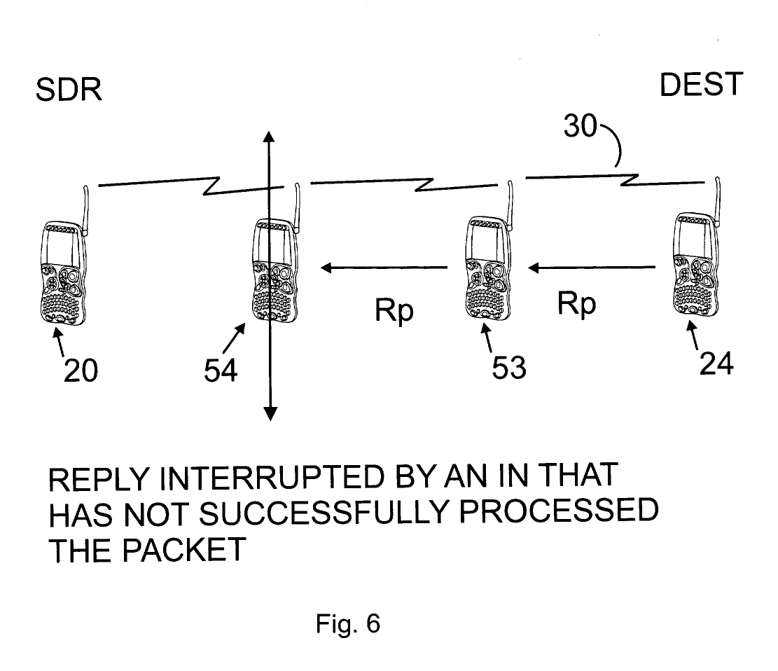

In this manner, the BQ packet 18 reaching the destination node 24 will only contain the intermediate mobile units addresses 26 (hence recording the route 30 taken) and their respective associativity ticks 28 (hence recording the stability state of the intermediate nodes 22 supporting the route 30) and the route relaying load, together with information on route propagation delays and hop count. (The route hop count can be deduced from the number of intermediate nodes 22 in the route 30). The resulting BQ packet 18 is variable in length and its format is shown in FIG. 6a.

The BQ packet 18 incorporates several fields including a type field 32 which identifies the type of packet that is being transmitted and allows appropriate prioritisation to be given to its handling. The BQ packet 18 also has a source node identifier field 34 and a destination node identifier field 36 which store the source and destination node addresses. A live field 38 indicates how far (how many hops) the BQ control packet 18 will propagate away from the source node 20 transmitting the packet 18. The BQ packet 18 then has a series of intermediate node address fields 40 and associated route qualities fields 42 provided. Each route qualities field 42 stores information about the route 30 at its corresponding intermediate node 22. More particularly, the route qualities field 42 stores the neighboring node's address 26, the corresponding number of associativity ticks 28, a route relaying load value 43, and a forwarding delay measure 44. The BQ packet 18 also includes a sequence number field 45 which stores a unique identifier for each packet and allows seen tables to prevent duplicate packet transmission. Finally, the end of the packet is identified by a cyclic redundancy check field 46 which enables the integrity of the received packet 18 to be confirmed.

The destination node 24 will, at an appropriate time after receiving the first BQ packet 18, know all the possible routes 30 and their qualities. Given a set of possible routes 30 from the source node 20 to the destination node 24, if a route 30 consists of mobile units having a high number of associativity ticks 28 (thereby indicating association stability), then that route 30 will be chosen by the destination node 24, despite other less stable but shorter hop routes. However, if the overall degrees of association stability of two or more routes 30 are the same, then the route with the minimum number of hops will be chosen. If multiple routes 30 have the same minimum-hop count, then the route 30 with the least delay is selected. An DRR route selection algorithm, which is executed at the destination node 24, is formally set out in Table 1. In addition, FIG. 6b shows the above described steps involved in carrying out the Route Discovery at the destination node 24.

The route parameters that govern the DRR route selection are: (a) degree of association stability, (b) route relaying load, (c) route length and (d) cumulative forwarding delay. The forwarding delay refers to all processing, queuing, carrier sensing and transmission delays. Forwarding delay measurements are exponentially smoothed and stored on a per-neighbour mobile unit basis, as in PRNs. The cumulative forwarding delay, therefore, reflects the end-to-end delay of the route concerned. Note that Table 1 presents a possible DRR route selection algorithm. However, the order of “route filtering” (i.e., which route metrics are regarded as more important than others) may change and is dependent upon the application quality of service specification.

Once the destination node 24 has selected the best route a REPLY packet 47 is sent back to the source node 20 via the route 30 selected. This causes the intermediate nodes 22 in the route 30 to mark their routes to the destination node 24 as valid. All other possible routes are then inactive and will not relay packets destined for the destination node 24 even if they hear the transmission. This, therefore, avoids duplicated packets from arriving at the destination node 24. Once a route has been selected, each of the intermediate nodes 22 in the network can be classified as active if it supports the chosen route 30 or inactive if it does not support the chosen route 30.

While the BQ packet 18 propagates to the destination node 24 each intermediate node 22 relaying the BQ packet 18 will know its hop count from the source node 20. Likewise, when the REPLY packet 47 propagates back to the source node 20, the intermediate nodes 22 can also compute their distances to the destination node 24. The REPLY packet 47 is variable in length and has the format shown in FIG. 6c.

The REPLY packet 47 is similar to the BQ packet 18 but omits the live field 38, the sequence number field 45 and each of the route qualities fields 42. Rather, after the series of intermediate node addresses 40, a summary field 48 is provided. The summary field 48 stores a summary of the selected route qualities such as aggregate degree of association stability 49, route length 50 and aggregate route relaying load 51.

When the REPLY packet 47 reaches the source node 20, the route 30 is established. The source node 20 can then proceed with data transmission over this route 30, where packets will be forwarded from one intermediate node 22 to another until they arrive at the destination node 24. Issues related to packet header and routing table formats, data acknowledgement and re-transmission are discussed later in this description.

Route Reconstruction (RRC) Phase In the DRR protocol, the selected route 30 is more likely to be long-lived due to the property of associativity. However, if unexpected moves do occur, the RRC phase procedures will attempt to quickly locate an alternative valid route without resorting to a broadcast query unless necessary. The RRC phase of the DRR protocol essentially performs four operations: partial route discovery; invalid route erasure; valid route update; and new route discovery (in the worst case). These operations may be invoked by any of the four node moves mentioned earlier.

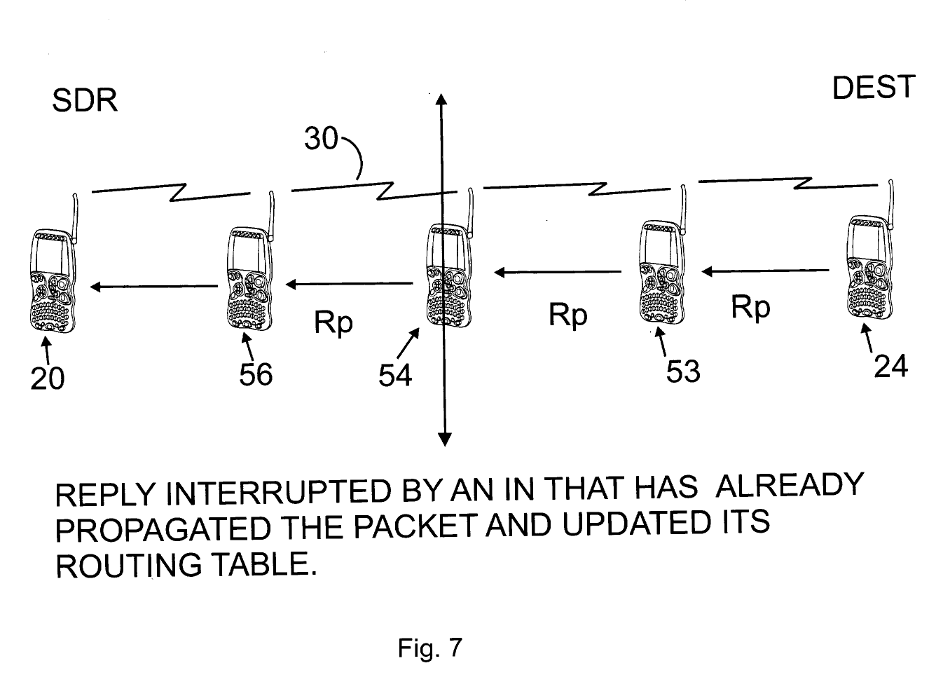

Referring now to FIGS. 7a and 7b, the way in which the RRC phase can be invoked during the BQ-REPLY cycle is explained. There may be some rare instances when the source node 20 never receives the REPLY packet 47 because of some unexpected “not-yet-selected” intermediate node's 54 movement as shown in FIG. 7a. In such circumstances, the source node 20 will eventually time out (BQ-TIMEOUT) and send another BQ packet 18. Since the downstream neighbor 53 of the migrating intermediate node 54 realizes the associativity change, it will send a route notification packet in the downstream direction, deleting all the downstream nodes' invalid routing table entries. Another situation occurs when a selected intermediate node 54 moves while the REPLY packet propagation is still in progress (see FIG. 7b). The upstream neighbor 56 of the migrating node 54 will perform a localized query process to discover a new partial route, while the downstream neighbor 53 sends a route notification packet towards the destination node 24, thereby erasing all invalid downstream nodes' routing entries.

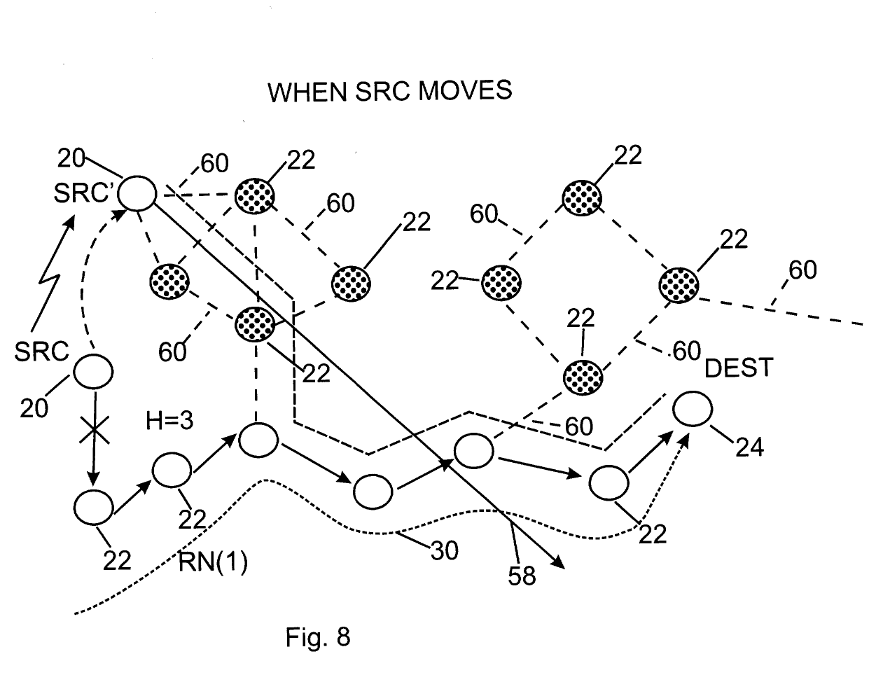

Turning now to the consequence of node movements after a valid route 30 has been established by the BQ-REPLY cycle, FIGS. 8a, 8b and 8c show respectively how the movements of the source node 20, the destination node 24 and intermediate nodes 22 are dealt with in the RRC phase.

FIG. 8a shows a network of mobile units comprising a source node 20, a destination node 24, intermediate nodes 22 and the various communication links 60 therebetween. The valid route 30 from source node 20 to destination node 24 has previously been established by a broadcast query. In the event of any movement by the source node 20, the RRC phase carries a route reinitialisation process via a broadcast query 58. This is the simplest and most efficient way of establishing a new route 62 to the destination node 24 and it also advantageously avoids multiple RRC phase conflicts as a result of concurrent nodes’movements.

Referring now to FIG. 8b, when the destination node 24 moves, the destination node's immediate upstream neighbor 64, or so called pivoting node 64, will erase its route.

The pivoting node 64 then performs a localized query (LQ[H]) process to ascertain if the destination node 24 is still reachable. “H” here refers to the hop count from the pivoting node 64 to the destination node 24. If the destination node 24 receives the localized query (LQ) packet, it will select the best partial route and send a REPLY packet back to the pivoting node 64, otherwise a time out period (LQ.sub.—TIMEOUT) will be reached and the pivoting node 64 will backtrack 66 to the next upstream node.

During the backtrack, the new pivoting node 64 will erase the route through that link 68 and perform a LQ[H] process 70 until the new pivoting node 64 is greater than half the route length, i.e., hop.sub.src-dest, away from the destination node 24 or when a new partial route 72 is found. If no partial route 72 is found, the pivoting node 64 will send a Route Notification (RN) control packet back to the source node 20 to initiate a BQ-REPLY cycle.

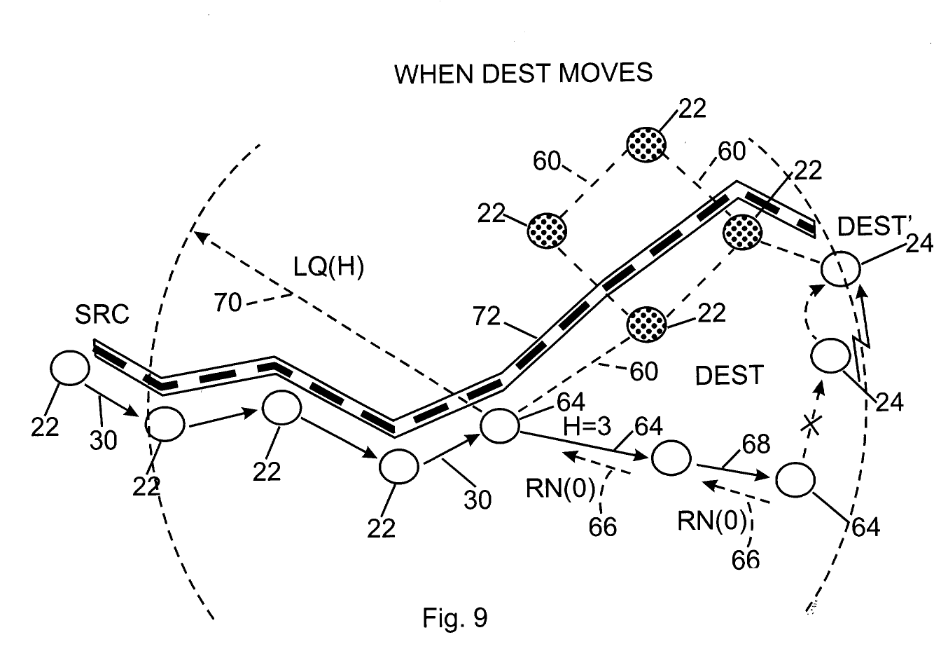

While the RN control packet is fixed in length, the LQ packet is not. The formats of the RN and LQ control packets are shown in FIGS. 9a and 9b respectively. The RN control packet 73 comprises an ORG ID field 74 which stores the pivoting node address and a STEP flag 76 which indicates the type of route notification that is to be carried out. When STEP=0 in the RN control packet 73, the backtracking process 66 is to be performed one hop at a time (in the upstream direction), while when STEP=1 this implies that the RN control packet 73 will be propagated straight back to the source node 20 to invoke a BQ—REPLY cycle or to the destination node 24 to erase invalid routes. The RN control packet 73 also comprises a DIR flag 78 which serves to indicate the direction of RN[1] propagation. The RN control packet 73 further includes the following previously explained fields: type 32, source address 34, destination address 36, sequence number 45 and cyclic redundancy check 46.

The LQ control packet 80 has exactly the same format as the BQ control packet 18 of FIG. 6a. However, the live field 38 is always set to be the Hop count value H.

Referring to FIG. 8c, the “upper arm” of a route refers to the intermediate nodes 22 and the destination node 24 that contribute to half the route length from source node 20 to the destination node 24. When any intermediate node 22 moves, its pivoting node 64 removes its outgoing node entry and its immediate downstream neighbour 52 propagates a RN[1] control packet 73 towards the destination node 24, thereby deleting all the subsequent downstream nodes’invalid routing entries.

An LQ[H] process is then invoked by the pivoting node 64 to locate alternate partial routes to the destination node 24. The destination node 24 may receive multiple LQ control packets 80, hence it selects the best partial route and returns a REPLY packet 47 to the pivoting node 64. This causes all intermediate nodes 22 between destination node 24 and the pivoting node 64 to update their routing tables. On receiving the REPLY packet 47, the pivoting node 64 updates its routing table entries and appends the next hop (outgoing) node ID into the data packet. This ensures that only one partial route is selected.

The LQ[H] process 70 is performed based on a suitable H value. If the pivoting node 64 is X hops away from the destination node 24 via the previous active route 30, then H=X will be used in the hope that the destination node 24 is still within X hops range (reachable via other paths) or shorter. This procedure, therefore, attempts to rebuild partial paths of equal or shorter lengths with respect to the previous partial path that existed, i.e., route optimization is built into the RRC phase.

However, if no partial route exists, LQ.sub.—TIMEOUT will expire and a RN[0] control packet 73 will be sent by the pivoting node 64 to the next upstream node 22, and the cycle repeats until the next pivoting node 64 has a hop count greater than half hop.sub.src-dest or when a new partial route to the destination node 24 is found.

The “lower arm” refers to the source node 20 and the intermediate nodes 22 that contribute to half the route length from the source node 20 to the destination node 24. If any of these nodes moves, a RN[1] control packet 73 is propagated downstream towards the destination node 24, and the pivoting node 64 performs an LQ[H] process 70 and awaits the destination node's REPLY packet 47. If no REPLY packet 47 is received, an RN[0] control packet 73 is sent to the next upstream node 64 and the new pivoting node 64 then invokes the LQ[H] process 70 again, but with a different value of H. This cycle continues until the new pivoting node 64 is the source node 20 (where the BQ-REPLY cycle is initiated to discover a new route) or a partial route to the destination node 24 is found.

A flow diagram showing the steps carried out in the RRC phase which is carried out when an active intermediate node 22 or the destination node 24 moves, is shown in FIG. 8d.

The migration of a subnet-bridging mobile unit 16 beyond the radio coverage of its neighbouring mobile units 2 will cause the mobile subnet 13 to be partitioned (see FIG. 2). If an existing route 30 does not span across the fragmented subnets 14,15, the route 30 is not affected and only the subnet-bridging mobile unit's upstream and downstream neighbours need to update their route and associativity entries. All other mobile units remain ignorant and do not perform any route updates. However, if existing routes 30 span across subnets i.e., the subnet-bridging mobile unit 16 is an intermediate node 22 of the route 30, then the route 30 is invalidated as the destination node 24 is no longer reachable, despite any LQ process 70 or BQ—REPLY cycle attempts. Under such circumstances, the localized query and route notification cycle will eventually inform the source node 20 about the partitioning and the source node 20 can then invoke BQ-REPLY cycles several times or it can inform the mobile user about the partitioning and prompt him or her to try later.

Race conditions exist due to multiple invocations of RRC procedures as a result of concurrent movements by the source node 20, the destination node 24 and intermediate nodes 22. The following explains how the DRR of the present embodiment is immune to “multiple-RRC procedures” conflicts and how one RRC procedure is valid ultimately.

Destination Node Migration RRC Procedure Interrupted by Upstream Intermediate Node Migration When the destination node 24 moves and while the RRC procedure is in progress, any upstream intermediate node moves will cause their respective downstream neighbours' route to be deleted. The new pivoting node 64 nearest to the source node 20 will perform the RRC procedure and all other RRC procedures will be passive when they hear the new LQ broadcast for the same route. Hence, only one RRC procedure is valid.

Upper-Arm Intermediate Node Migration RRC Procedure Interrupted by Lower Arm Intermediate Node Migration This situation is resolved in the same way as the above-mentioned situation. Note that the same argument can be applied to the case when a LQ process 70 has to be aborted and a RN[1 ] control packet 73 has to be sent to the source node 20 to invoke a BQ-REPLY cycle but is hindered due to some upstream intermediate node's movements. The new pivoting node 64 nearest to the source node 20 will swamp the earlier RRC procedures by invoking a new LQ process 70.

Lower-Arm Intermediate Node Migration RRC Procedure Interrupted by Upper Arm Intermediate Node Migration While a lower arm intermediate node migration RRC procedure is taking place, any movements by any upper arm intermediate nodes 22 will not result in a LQ[H] or a RN[1] process being initiated since a lower arm intermediate node 22 has earlier sent an RN[1] control packet 73 downstream to erase invalid routes. If the RN[1] control packet 73 does not succeed in propagating to the destination node 24, the LQ[H] process 70 initiated by the lower arm intermediate node 22 will also serve to delete these invalid routes.

Intermediate Node Migration RRC Procedure Interrupted By Destination Node Migration This has no effect on the RRC procedure, as the LQ[H] process 70 uses a localized query approach to locate the destination node 24. Once the destination node 24 is associatively stable and is reachable from the pivoting node 64, the RRC procedure will be successful.

Intermediate Node Migration RRC Procedure Interrupted By Source Node Migration While lower or upper arm intermediate node migration RRC procedure is in progress, any moves by the source node 20 will result in a BQ-REPLY cycle, which will swamp out all on-going localized query, REPLY and route notification processes related to that route. Hence, unfruitful and stale RRC procedures will not continue and a new route will be discovered via the BQ-REPLY cycle.

Source and Destination Nodes Moving Away from Intermediate Nodes When this occurs, RRC procedures as a result of destination node and source node migration will be initiated. However, the BQ-REPLY cycle initiated by the source node 20 will again swamp out all unnecessary ongoing RRC procedures.

Destination Node Migrating Into Source Node's Radio coverage Range When the destination node 24 migrates, RRC procedure is achieved via the LQ[H] process 70. However, when the destination node 24 is within the source node's radio coverage range, packet duplicates will result at the destination node 24 since the destination node 24 now receives packets from the source node 20 directly and also from the original source node 20 to destination node 24 route. Hence, to avoid packet duplicates and non-optimal routes, the source node 20, on discovering that the destination node is within range and is in stable state, will send a RN[1] control packet 73 downstream to erase the existing route and will re-establish a new single hop route with the destination node 24.

During a LQ-propagation and REPLY-await process, if any of the upstream nodes (i.e., lower arm intermediate nodes 22 ) break up, an RN[1] control packet 73 will be propagated downstream, erasing all the downstream intermediate nodes' route entries. The existing pivoting node 64 will ignore any subsequent REPLY to its LQ process. The new pivoting node 64 will resume with a new LQ and REPLY process. It should be noted that downstream nodes’migrations are not of concern during the LQ and REPLY process.

In DRR, no attempt is made to retain alternate routes, as maintaining them causes overhead. Only one route will be selected and only one route is valid for a particular route request. The avoidance of using alternate routing information means that problems associated with looping due to intermediate nodes having stale routes are absent and there is no need for periodic network-wide broadcast and route updates.

Any alternate route will have to be discovered via a LQ or BQ process, which may give rise to better (shorter hop and long-lived) routes. The destination node 24, on receiving multiple BQ or LQ packets, will select the best route and reply to the source node 20. During the LQ-REPLY-RN cycle, invalid intermediate nodes 22 routes are erased by RN[1] control packets 73 and intermediate nodes 22 forming the new partial route will have their route entries updated when they have relayed the REPLY packet 47 from the destination node 24 to the pivoting node 64. If the LQ-REPLY-RN cycle fails, the subsequent new pivoting node 64 will have its route entries erased by RN[0] packet 73 during the backtrack process 66. If all the possible backtrack LQ-REPLY-RN cycles fail, all the upstream nodes will have their route entries erased via RN[0] and RN [1] control packets 73 and the source node 20 will then revert back to the BQ—REPLY cycle.

Finally, for the case of a BQ process, any intermediate nodes 22 receiving a BQ packet 18 and having invalid routes will have their invalid routes erased, therefore ensuring that no invalid routes exist in the intermediate nodes 22.

Route Deletion Phase When a discovered route 30 is no longer desired, a route delete (RD) broadcast is initiated by the source node 20 so that all intermediate nodes 22 update their routing table entries. A full broadcast is used as compared to directed broadcast. Since the nodes in a route 30 change during the RRC phase, using a directed broadcast is unsuitable unless the source node 20 is always informed about any changes to the route 30.

FIG. 9c shows the format of an RD control packet 82. The RD control packet 82 has the following fields which have previously been discussed regarding the BQ control packet 18 and the RN control packet 73: type 32, source node address 34, destination node address 36, live 38, sequence number 45 and cyclic redundancy check 46. Similar to the BQ control packet 18, the RD control packet 82 has the live field 38 set to infin. to achieve a full wave broadcast.

Having described the procedures involved in DRR, the formats of the packet headers and of the tables provided at each mobile unit are now described hereinafter.

Since a long packet header results in low channel utilization efficiency, each data packet header only contains the neighbouring node routing information, not all the nodes in the route. Each intermediate node 22 renews the next-hop information contained in the header before propagating the packet upstream or downstream. Hence, a hybrid routing scheme which is a combination of broadcast and point-to-point routing is realized. The purpose of some of the individual fields of the packet header is summarized in Table 2.

A typical routing table of a node supporting existing routes is shown in Table 3. The table reveals that every node supporting on-going routes will map incoming packets from a particular upstream node to the corresponding out-going downstream node. Every node will also keep track of its distance (hop count) to the destination node 24 and a record of the total routes that it is currently supporting.

The neighbouring or associativity table is usually updated by the data-link layer protocol, which will generate, receive and interpret identifier beacons from the neighbouring mobile units 2 or base stations and pass this information up to the higher protocol layers. Nomadic collaborative applications can then utilize the neighbouring table information to update their participants' present and absent lists. The structure of a neighbouring table is shown in Table 4.

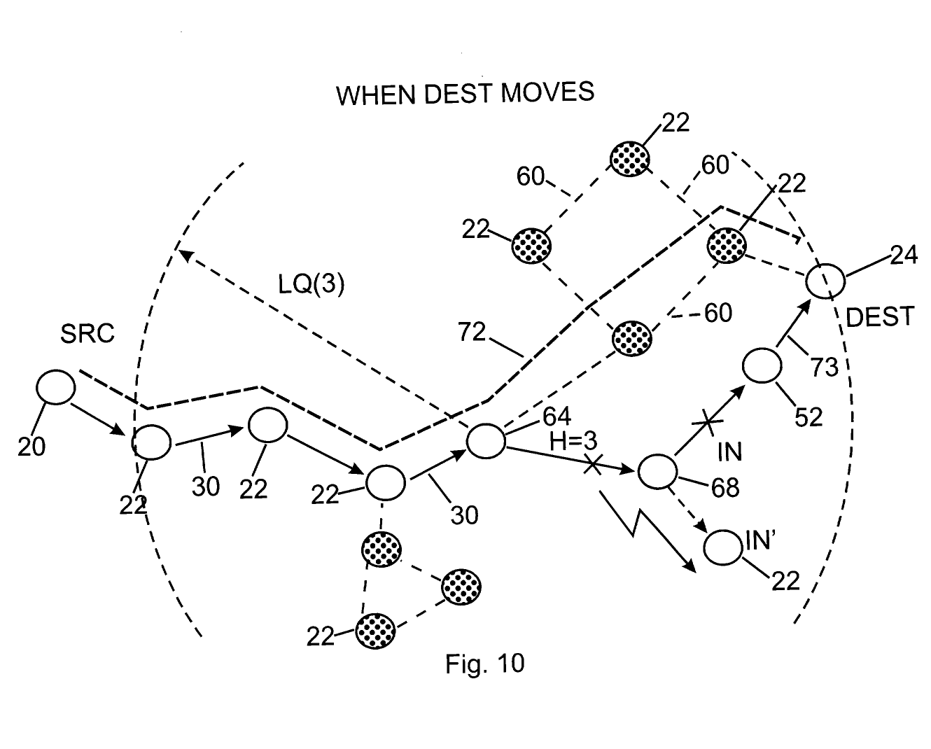

While the BQ process is activated via a radio broadcast, the LQ query process is invoked via a localized broadcast. To prevent mobile units 2 from processing and relaying the same BQ, LQ or RD packet 18, 80 or 82 twice, BQ, LQ and RD seen tables are provided. If the received control packet type 32, route identifier source and destination node addresses 34,36 and sequence number 45 match an entry in the seen table list, then the packet is discarded. The contents of these seen tables is erased after a certain time-out period. This time-out period is long enough to allow a mobile unit's neighbours to forward the BQ, LQ or RD control packet 18, 80, 82 to their corresponding neighbours, as illustrated in FIG. 10. More particularly, a mobile unit Na having transmitted it BQ(1) control packet to its neighbours Nb, Nd, will hear transmissions from those neighbours Nb, Nd, when they forward the BQ(2) control packets to their neighbours. Hence, the BQ(2) packets will be ignored by the mobile unit Na. The BQ(1) entry in the BQ control seen table of mobile unit Na, is not erased until at least after the end of the period of receiving passive acknowledgements from all of the neighbours Nb, Nd of the mobile unit Na.

On the other hand, because the REPLY and RN control packets 47,73 utilize directed broadcast (since intended recipients' addresses are contained in the control packet), seen tables for these packets are not necessary.

Turning now to data flow acknowledgement and packet transmission, the present embodiment of the invention implements end-to-end flow control by adopting the scheme used in PRNs, namely a passive acknowledgement scheme for packets in transition. When a node receives a packet and performs relaying via a radio transmission to its neighbours, its previous neighbour that has sent it the packet will have heard the transmission and hence this is indirectly used as an acknowledgement to the packet sent. On the other hand, active acknowledgements will only be sent by the destination node 24 as it no longer has a neighbour to relay the packet to. Hence, this provides a data flow acknowledgement mechanism for packet forwarding in an ad-hoc mobile network, which is not present in any of the existing ad-hoc mobile routing schemes (other than PRNs).

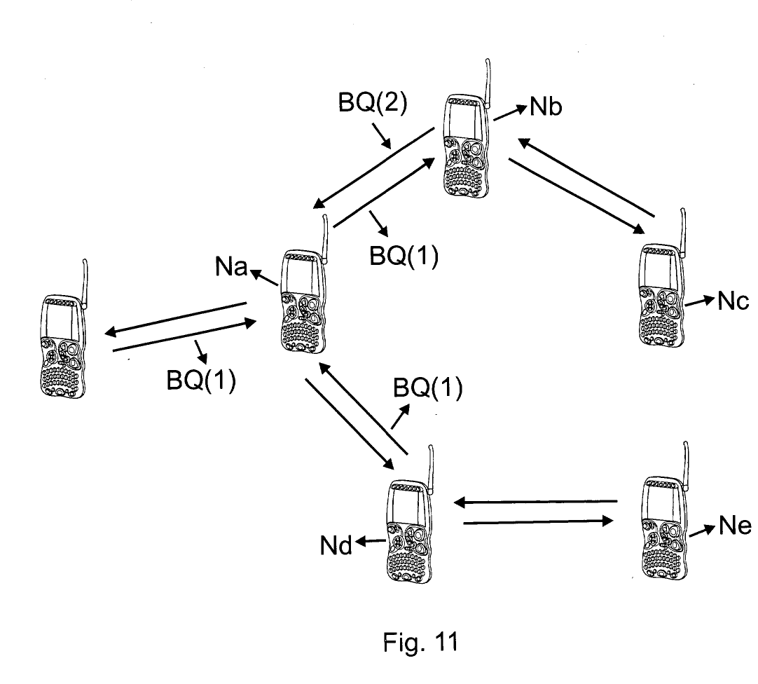

Referring now to FIG. 11, while the data flow acknowledgement scheme allows forwarded packets to be acknowledged, there are situations where the acknowledgements never reach the intended receiver. This can be a result of radio interference which causes a sudden loss of radio connectivity at 84.

Hence, if a mobile unit 2 has forwarded a packet and does not receive an acknowledgement with in a certain time interval, it retransmits at 86 the packet for a maximum of X times. The mobile unit checks at 88 to see if the limit of X transmissions has been reached and if so, the neighbouring mobile unit is considered to be out of reach at 90 and RRC procedures at 92 are invoked. If, however, the check for a radio link-up at 94 is positive, the packet forwarding procedure at 96 continues. Otherwise, the packet is retransmitted again at 86.

The present embodiment of the invention includes a unit discovery mechanism. When an associativity is formed (through recognizing a neighbouring mobile unit's identifier beacon), a mobile application controlling the network is informed of the new mobile user who can then participate in nomadic collaborative computing. This can, for example, simply appear as an icon on the user's screen which when clicked, reveals details of the new participant. The new associativity of one mobile unit with another can also be propagated to the nodes' neighbours, so that all other neighbouring mobile units within the mobile subnet can be made aware of the existence of the new user. Alternatively, a mobile unit can choose only to be aware of its immediate neighbours and can later perform an on-demand neighbour discovery broadcast when it desires to communicate with mobile units outside its vicinity. As a result of network connectivity, a mobile unit can also discover what services are available from which other mobile units.

The assessment of the quality of a particular route, as is carried out in the BQ process at the destination node 24 on receiving BQ packets 18, requires analysis of various routing qualities. Conventionally, routes are assessed by the following qualities: (a) fast adaptability to link changes (recovery time), (b) minimum-hop path to the destination, (c) end-to-end delay, (d) loop avoidance and (e) link capacity. Some protocols prioritise the fast adaptability characteristics by carrying out frequent broadcasts in order to obtain fast route convergence. However, fast adaptability at the expense of excessive radio bandwidth consumption is undesirable. Furthermore, the qualities of a good route should not be based solely on the number of hops and the end-to-end delay. Rather, the new routing metrics which are used in the present embodiment are listed in Table 5.

The longevity of a route is important, because the merits of a shorter but short-lived route will be denigrated due to frequent data flow interruptions and the need for route reconstructions. In addition, even relaying load distribution is important in an ad-hoc mobile network, as no one particular mobile unit should be unfairly burdened to support many routes and perform many packet-relaying functions. This latter characteristic also helps to alleviate the possibility of network congestion. Finally, since the associativity of a mobile unit with its active or inactive neighbours and the route relaying load, i.e. the total number of active routes supported by the mobile unit also reflect the number of contenders within a wireless cell, the approximate aggregated throughput (link capacities) for the selected route can be made known to the mobile user prior to transmission, therefore allowing the user to either proceed with or abort the transmission.

The present embodiment can also be integrated with Wireless Local Area Networks (WLANs) which incorporate base stations (BS). In fact, it is desirable for a mobile unit to be able to function in both ad-hoc or BS-oriented WLAN environments and this is one of the functional specifications laid down by the IEEE 802.11 committee. When a mobile unit receives identifying beacons generated by other mobile units, it automatically invokes the ad-hoc routines to support mobile-to-mobile communication. However, when it receives identifier beacons generated by the base stations, the mobile unit knows that it has access to a wired network and hence conventional routing protocols supported by location management, registration, handovers, etc., can be invoked. The mobile application controlling the network can be made intelligent enough to decide which communication mode, i.e. ad-hoc or BS-oriented, best suits the service requirements.

In addition, both ad-hoc and BS-oriented modes can be combined to provide fault tolerance in a BS-oriented WLAN against base stations' failures. More particularly, when a mobile unit sees a base station, its associativity ticks with the base station will be high. But these associativity ticks will be reset on the base station's failure (equivalent to an associated node moving away). Hence, under such circumstances, the mobile unit can apply associativity-based ad-hoc routing to re-route its packets to its neighbouring mobile units who may have access to other base stations.

The present embodiment can also incorporate a dynamic cell size adjustment scheme. High associativity of a node (mobile unit) with other nodes enhances its communication capability and produces shorter hop routes. However, an increase in the number of active nodes in a wireless cell can cause greater contention for the available wireless bandwidth, resulting in lower throughput per mobile unit. In an environment which is congested with mobile units, it is possible to dynamically adjust the transmission power of each mobile unit such that both the cell size and the number of neighbours are reduced in order to achieve a reasonably high throughput while still maintaining acceptable routing performance. It has also been shown earlier by Takagi and Kleinrock that spatial channel reuse obtained by reducing mobile unit transmission power to a level where only a few neighbours are within range, gives rise to an improved throughput.

Hence, the throughput of a wireless network depends on the media access control (MAC) protocol (such as ALOHA, GRAP and CSMA) and the spectrum bandwidth allocation strategies. While dynamic cell adjustment allows the wireless cell capacity associated with each ad-hoc mobile unit to be increased, the formation of longer routes may result in longer end-to-end delay. There is also an increased probability that the ad-hoc mobile network will be partitioned into multiple subnets.

The dynamic cell size adjustment scheme of the present embodiment is activated when a mobile unit finds itself in a congested environment (i.e., having many neighbours and heavily loaded with route relaying functions), contending for the limited available wireless bandwidth. Based on the mobile unit's knowledge of which neighbouring mobile units are active (i.e., supporting routes similar to itself) and which are not, and the distances of these neighbouring mobile units from itself (computed from the received power levels of identifier beacon signals), the mobile unit can dynamically reduce its transmission range to exclude inactive neighbours, i.e. those mobile units which are not part of the selected route, but include all currently active neighbours, i.e. those neighbours which are part of the selected route 30.

In this manner, the dynamic cell size adjustment scheme of the present embodiment does not affect the operation of the DRR protocol. Existing routes remain unaffected and no RRC phases need to be invoked due to the wireless cell size reduction. This advantageously gives rise to a reduction in the transmission power of the mobile unit and to an increase in capacity over a given area (due to less beaconing traffic and fewer contenders). This dynamic cell size adjustment scheme is only advantageous when used with the DRR protocol because the gain in power reduction and bandwidth enhancement is only substantial if the route is associatively stable.

The outstanding feature is that no RRC procedures are needed so long as the property of inter-dependent associativity remains valid. When this property is violated, the protocol will invoke a LQ or BQ process to quickly locate alternate routes.

So far, the DRR protocol is concerned with discovering routes from the source node to the destination node. However, for bi-directional traffic, the routes for each source can be different. In this situation, the RRC process for each stream is performed independently, even though the moves can sometimes be related to a common mobile unit.

Whilst there has been shown and described an embodiment of a routing method in accordance with the present invention, it will be appreciated that the described embodiment is exemplary only and is susceptible to modification and variation without departure from the spirit and scope of the invention as set forth in the appended claims. For example, the present DRR protocol considers routes with the highest degree of association stability and acceptable route relaying load as the most important quality of service metrics, followed by minimum-hop routes and routes with minimum cumulative forwarding delay. However, the order of route filtering in DRR route selection can be changed in accordance to the application quality of service requirements. If minimum cumulative forwarding delay and throughput are regarded as more important factors, then the protocol can be arranged such that these metrics override the others.

The specification of the order of quality of service importance has to be mapped to the underlying routing protocol in some manner. After the mapping, it is possible to append such quality of service requirements into the BQ and LQ control packets 18,80 during the full and partial route discovery processes so that the destination node 24 can be informed of the desired quality of service requirements. In particular, during a RRC process, it is desirable for the pivoting node 64 to retain the user specified quality of service requirements that it has learned during the processing of the earlier BQ control packet 18 so that this information can be appended in the LQ control packets 80 to be broadcast.

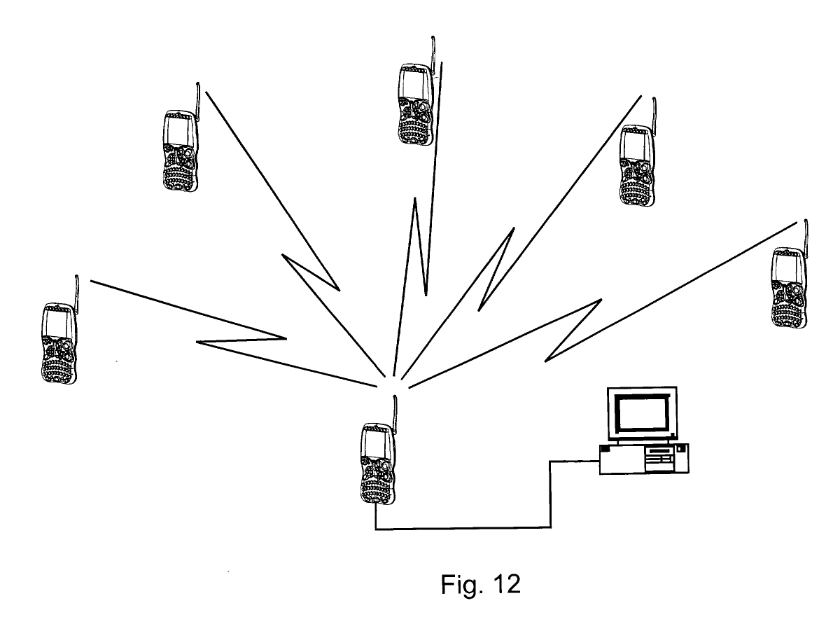

The principle of associativity can also be applied to base station oriented Wireless LANs in the sense of network resource adaptation. For example, as shown in FIG. 12,a mobile unit Na initiates a communication session with end unit Eo over route X. The mobile unit Na could be viewing a video sent by end unit Eo (which is say a video server). We will assume that the wireless Cell ‘A’s current available wireless resources fulfil the need for transporting this video stream from the end unit Eo to the mobile unit Na.

However, when the mobile unit Na moves to wireless Cell ‘B’, this cell ‘B ’ could be crowded with many other mobile units (such as Nb and Nc) and hence the available resources could be insufficient to support this on-going video application running on mobile unit Na. Instead of forcing the application to terminate, one strategy could be to degrade the resource requirement to a lower value. This means that the video image viewed at mobile unit Na in Cell ‘B’ could be of a lower resolution or a smaller image size.

Broadcasting MethodA method of broadcasting the device status information thru wireless communication system. Every device enabled with RF transceiver can periodically broadcast its personal information with indication of a version of the information. A receiving device that get the broadcast data can only check for data version stored in its local cache, and if the version is changed, notify an applications about new value of the personal information corresponded to the devices sent the data.

A method of broadcasting the device self status info together with (including) status version indicator to (within) wireless communication system, that can avoid possible data loss and optimizes the status update process.

Fail Safe Operating systemThe invention belongs to electrical technology, more specifically to digital data processing in computers, and it concerns building file structures for the operating systems intended for use in devices with a very limited volume of random access memory i.e., around several dozen kilobytes.

There is one well known method of boosting faulttolerance by creating backup copies when recording on the carrier. This method is realized, for example, in the file system FAT12 (MS DOS)—a famous file system provided for small devices (Microsoft Extensible Firmware Initiative. FAT32 File System Specification. FAT: General Overview of On-Disk Format. Version 1.03, Microsoft Corporation, Dec. 6, 2000, p, 7-34).

In this popular file system the whole carrier is split into these areas: the FAT area (File Allocation Table) and the file data area. In case of damaged FAT area the whole carrier is considered to be damaged. To protect itself from failures the FAT area contains two copies of data, and in case of one of them damaged, but the other intact, it does not destroy the carrier completely, thus, due to redundancy, certain positive stability of a system is achieved . However the physical reliability of the carrier itself is the primary factor of positive stability of the FAT12 system. What is also important in such a system, that when saving to file, not only the block containing the data is recorded but also two more blocks of FAT area can be recorded as well (remember 2 copies of data in this area). Thus, instead of a minimally required recording of one block (remember, the data in this block has changed) recording of two more blocks of the carrier may well happen, which is conditioned by the logical specifics of the file system. However, for the carriers with a small amount of the recording cycles this data saving algorithm reduces the service lifeof the carrier.

This invention aims to tackle the technical issue to provide a minimum number of recording to disk (carrier) cycles with the admissible cacheing of the data shorter than one block of the carrier, in order to provide a high fault tolerance of the file system and preserve its service capability on the carriers with bad or failing-to-record blocks of the target devices with an extremely limited volume of random access memory (around several dozen kilobytes). The achieved technical result in this case consists in a positive stability of the file system against abrupt interruptions of the operation, for example, at power supply outages or in connection with any other failure of a device with its service capability preserved on the carriers with bad or failing-to-record blocks.

In terms of the method the above technical result is achieved due to the fact that within the method of boosting the fault tolerance of the file system for carriers with a limited resource of the record operations all blocks of the carrier reserved as accessible, have an identical format. Each block of the carrier is given: status (busy/free) attribute for determining its status as busy of free for recording; file identifier of the logical number of the file block; and the system establishes the data size in the block. In this case the format of the first block of the file will additionally have the file name. At its star-up the system attributes to each set of the logical block numbers its corresponding virtual physical number from 0 to Nmax , where Nmax is the maximal number of the block dependent on the carrier capacity, and establishes the blocks with the occupation status attribute, by which it establishes their logical numbers and belonging to a particular file. In case of a failure of a block with a specific logical number to record data, the system searches for another block free—for recording and records data into the block, in which case the system marks the failed block with a damage attribute and gives the physical number of the failed block to the logical number of the block, in which the record was actually made.

The above-mentioned result regarding the design is achieved due to the fact that a protected file system for carriers with a limited recording operations resource contains carrier blocks reserved as accessible and having identical formats storing in a particular part of each block a busy attribute for defining the block as occupied or free for record, a file identifier distinct from that of the other files, a logical number of the block of the file and the data size in the block, in which case for the first block of the file its format additionally contains its file name, and at least its creation date and access attributes. The system is designed with a function establishing concurrence of the logical number of each block to its virtual physical number, a function establishing a failure to record in one of the blocks, a function marking the block as damaged, a function searching and detecting a free block with a free-for-record attribute, a function recording the data in a free block, and a function establishing concurrence of the logical number of the failed block to the physical number of the block, in which the record was made.

The pointed attributes are important, since they form a steady set of essential attributes, sufficient for obtaining the required technical result.

The structure of the file system for block carriers suggested under this invention has a number of advantages as opposed to the above-mentioned popular FAT12 system. Under the invented system the carrier has neither special areas for allocation of catalogues, nor file allocation tables (FAT) or other technical information. At a failure of the carrier blocks, an internal reassignment of the logical block numbers is applied affecting the physical block numbers, however the blocks reassignment table is not stored anywhere between the launch sessions of the file system and is restored at initial start of the operating system (OS) during initialization of the program part of file services. The price for storage of the data of files organization is minimal and is paid for the headers of the carrier blocks, hence all blocks allocated for the file system have an identical format, which makes the program implementation of such a file system considerably simpler.

At any local update of the data, for example, saving to file or changes of its size per block, both shrinking or growing, only one block of the carrier is modified (physically recorded), which reduces the recording operation to a minimum.

At abrupt power outages or damaged hardware only the file, that was deleted, cleared or recorded may turn out to be in an incorrect condition. It has to be noted that this file will look correct from any technical point of view though possibly incorrect from the view point of the programs working with the data recorded in this file. This file appears cut off, that is shorter by length, than expected.

Simple logical rules acting as invariants of the file system correctness, allow to realize a simple program of automatic restoration of the file system, which despite of the above-stated specifics, is sometimes necessary in case of hardware debugging or development. What is also has to be noted, is that in the devices with no guarantee against corrupted logic of the OS operation because of external programs or units, the possibility of restoration of the file system is an important feature. The restoration can be made completely automated and not to require interactive user action. These specifics allow making restoration of the file system a hidden operation at launching of the OS file services.

In a protected file system all blocks of the carrier reserved by the file system as accessible, have an identical format consisting in storage in either part of the block of the following data:1. The attribute bit: the block is occupied. Those blocks in which this attribute's value is true are considered as blocks containing data of a file. If this attribute's value is false, such block is considered as a free block of the carrier.

2. The unique file identifier: some bit value (for example, number), characterized by the fact that it is unique for different files, that is, using this attribute any file on this carrier can be unequivocally identified.

3. Logical number of the file block.

4. The size of data in the block. Number of the bytes considered as data, and recorded in this block. This value is important for the last block of the file, which can be filled incompletely.

If a block is the first block of a file, than it has a record (as initial data) of such file attributes as: file name, file creation date, access attributes, etc.

Only the file name is necessary for presenting such system as file system, that is a set of named data storage units. Other attributes are auxiliary and rather traditional.

The technical specifics, such as calculation of check sums of the blocks etc., are encapsulated inside the block driver of the device, and not included in this statement.

Thus, each block of the carrier contains information whether it is occupied or free, and if it is occupied, than under which logical number it operates in the file chain and to what file it belongs. Availability of this information makes it possible building in RAM structures required for a fast access to each block of a particular file positioned on the carrier at initialization of the file system.

The file system works with logical numbers of the blocks, while the multitude of the logical numbers is a mirror image where every logical number has its corresponding physical number.

At start-up of the file system all logical numbers of the blocks are established as equal to physical numbers, as you remember, the data carrier looks simply as an array of the blocks with numbers from 0 up to Nmax , where Nmax is the maximal number of the block dependent on the capacity of a specific carrier.

In case of a data recording failure by a block with a particular logical number, the block readdressing unit attempts to find, any which way, a free block of the carrier to where the record can be made. If such block is found, the recording is made in there, and the logical number of the block becomes associated with the physical number of the found block. If such block is not found, this is considered as the device overflow, and the file system signals thereof to the applications.

Let us assume that an attempt was made to record in the logical block with number X, that coincided with the physical number X (see. the provision on initialization of the logical numbers at start-up of the file system), and the physical block X appeared to fail. If this is the case, the system immediately marks it as bad, and attempts to make a record in one of the free blocks on the carrier. If such block is found (by scrolling through free blocks), and the recording is a success, than this logical number X is put in concurrence the physical number of the found block.

The file system is logically insulated from the hardware by the block driver, which sole operation is to record the block with a stipulated physical number on the carrier, and to read the block with a given physical number from the carrier in a specified area of the memory.

What is important to note, that it is unnecessary to keep the readdressing information on the carrier, since this information is required only during one session of the file system operation, and the data can be located in the random-access storage (RAM) only. It stems from the fact that the physical number of the data bearing block is not present anywhere on the carrier, and the file system at initialization does not need this knowledge at all.

The price for the described advantages is a certain amount of time spent on initialization of the file system at the start-up of the OS, however, even on the lowpower devices with only several thousand blocks on the carrier, building of the file system takes a few seconds, and the carriers with lots of blocks always have a capacity to hide the initialization, starting it as a separate background task, or splitting the carrier into zones which are, as a matter of fact, separate file systems, and initialize them at the first request addressed to such zone.

RF Power ControlA method of output power control.

Necessary technical result lies in increasing flexibility of output power control, acceleration quality connection, lowering power consumption and minimization overall dimensions and weight device.

A known method for output power control in retransmitting relay device presumes setting a lot of output power levels, and once a day to learn session rate quality connection, on the base of this estimation choosing appropriate power output level remaining constant over next session.

Shortcomings of the method are: complexity of the hardware and software decision, considerable duration of procedure, necessity of base station.

Also there is a known method for output power control in mobile phone, wherein all control functions take place on basic station, with further transmitting directive notes about power level output for each mobile phone.

Drawbacks of the method are: placement of all hardware and software resources for said method realization on basic station, which haven”t strong limits of overall dimensions, weight and power consumption and assigning to base station all leading and organizing functions on estimation, selecting and setting processes. This method doesn”t fit portable devices as not managed by base station.

Activity description Switching on higher output power level is carried out in the next cases:—the presence of indicator about replying power level raising in the inner device list field,—on receiving a ping-signal from device in irregular time intervals and/or with the lower value of RSSI, than predefined as satisfactory signal quality. In this case the device is marked in internal list as demanding higher output power level for transmission,—a signal is received from a device with the value of RSSI lower than predefined one as satisfactory signal quality. In this case the device is marked in internal list as demanding higher output power level for OLE_{—LINK}3transmissionOLE_{—LINK}3,—block of information received from a device contains special indicator in its header, demanding to raise power transmission mode. In this case the device is marked in internal list as demanding a higher power for transmission.

on sending message at raised power special flag is set in block of information header, requiring raised power for reply.

Transmission on regular power level is performed in the next cases:—the absence of label demanding the raised power level in internal list special field,—if the information received from a device contains indicator for regular power reply mode in its header. In this case mark for raised power reply mode in internal list is cleared.

if the information received from a device with the value of RSSI exceeding predefined level of signal satisfactory quality and with indicator not demanding raised power reply mode. In this case the mark for raised power reply mode in the list is cleared.

if information received from a device with the maximal value of RSSI and with indicator demanding raised power reply mode. In this case the mark for raised power reply mode in the list is cleared.

Use of two levels of RSSI (Received Signal Strength Indicator) as threshold values for quality of received signal for transmission power switching. (Predefined level, used as lower bound of satisfied quality of signal and maximized value of received signal level).

Devices that have received that signal add or refresh the data about the source device in it”s special list of all visible devices in the area of radio coverage.

Each device during process of data exchange estimates the received signal quality of each partner in the range coverage.

Device can transmit information on normal or raised power level.

If ping-signal is received from a device in irregular intervals, exceeding predefined value then the device is marked for transmitting at raised power level mode.

If signal from a device is received with the value of RSSI less than predefined value then the device is marked for transmitting at raised power level mode.

If reply is to be sent on raised power level then special indicator is set in the packet header to show it.

If packet received from a device has raised power indicator set then the device is marked for transmitting at raised power level mode.

If packet from a device has raised power flag cleared then mark for transmitting on raised power level for the device is removed.

If packet from a device has raised power flag cleared and the value of RSSI is high then mark for transmitting on raised power level for the device is removed.

If packet from a device has raised power flag set and the value of RSSI is maximal then mark for transmitting on raised power level for the device is removed.

Global Messaging Transport.

This is a network technology and data transfer invention, which concerns data communication for networking subscribers equipped with portable devices combined with limited-range radio transceivers.

A multievent-oriented operating system is running on the portable devices. Incoming messages are the main source of events in the operating system. Intercommunication is based on message exchange between processes. Each process embraces an incoming messages” queue. The basic paradigm of the application running on the device lies in waiting of typified event that is a message. In the waiting state the process is not active and doesn”t spend processor time.

Messages are the data structure including: message identifier (type) set of parameters of different types in the message header of relatively little size optional data buffer of variable length.

In particular, a message has the following attributes: portable device-receiver address, and identifier of process-receiver running on the device portable device-sender addressA device identifier is a unique fixed-length”number (CyID) assigned at manufacturing. Messages can be transferred transparently for applications both locally (to another or the same process on the same portable device) or remotely (to process on the other portable device). Transport system automatically defines a possible messages delivery way to the addressee. In case of remote transferring, a sender is notified about the delivery result. A delivery result notification contains unique fixed”identifier of the sent message.

One of the realized methods of messages transfer between devices is transfer over radio channel. For this the CyRF Communication Protocol (CyRFCP)×.30 is used. Protocol supports message layout into packets of the most fit length at transferring, confirmation of received ones, resending the lost ones and forming packets into the message on receiving. Protocol includes also collecting statistic and network information about devices around, device distribution on the different radio frequency channels. One of all used channels is assigned for coordinate system information transfer, others are for application tasks data.

One of disadvantage is that the message transfer method is possible in the scope of radio-coverage area of data communication participants only, which may be not so wide. In order to extend data communication area, protocol also supports special kind of devices that work as reof messages. The main task of a reis to transmit messages via Internet or Intranet transport to devices located outside the coverage area of the message source (sender), but close to another reEvery ordinal device tracks the presence of its nearby reif any one exists in the scope of radioof the device, in a time. All messages sent by applied tasks running on the device to an address, which is not listed among detected devices, are sent to the most nearby reThe message exchange between regoes under the CylP protocol (Cybiko Internet Protocol) through interaction with servers called CyCS (Cybiko Communication Server).

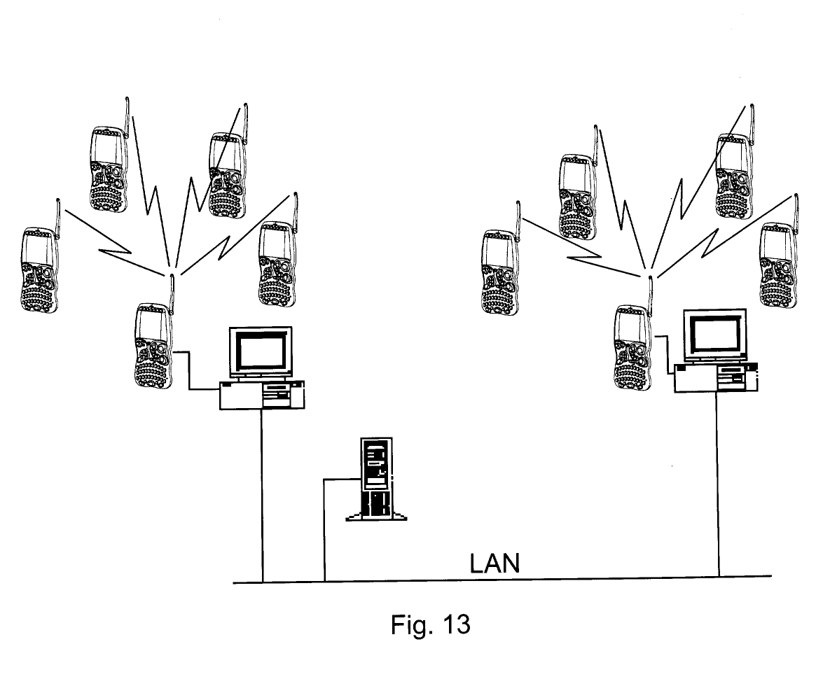

A re-transmitter collects and stores run-time information of portable devices active in the visible section (scope) of its local RF sub-network (FIG. 14). It readdressed messages within its own visibility area. In order to exchange information with the server and other rea reuses the communication interface CyIG (Cybiko to Internet Gate). When connection with CyCS via Internet/Intranet exists, it operates in the global visibility area, performing WAN and LAN message exchange (FIG. 15) through interaction with the server. As connection with CyCS is established (and, possibly, authenticated), it periodically informs the server about visible devices and reports the connection quality, as well as the emergence of new devices and the disappearance of the old ones in the visible radio network scope. Transmits all messages addressed in the framework of its own radio sub-network to a device outside the scope of visibility, as well as delivers all messages addressed to device inside the coverage area sent by device out of the area but close to another active CyIG implementor, by interaction with CyCS. The simple reis a portable device connected via USB or RS-232 to a personal computer (PC), which has launched the special communication software. One of reof such type is currently well known as CyWIG (Cybiko Wireless Internet Gate).

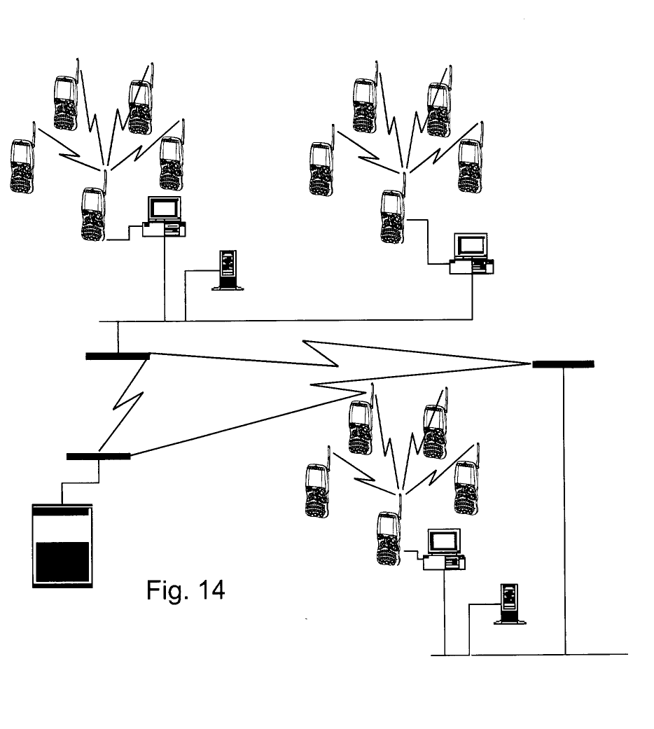

Thus, the CylP protocol unites the devices with the use of CyIG and CyCS into a global CyNet network and allows exchange of messages sent by the applications on the devices world-wide (FIG. 16).

CyCS server is the key element of the CyNet network. It keeps the run-time information on active CyIG interfaces and devices visible in the framework of its coverage area, and supports global lookup of an active device, and ensures of message exchange between CyLGs, directly or through CyCS. The CyNet can have only one CyCS server, or a certain hierarchic structure of CyCS servers for allocation of visibility areas control.

Virtualdevices can also exist in CyNet. A virtual device is addressed by CyID, but is actually a server applications performing some special tasks for devicescommunicating with it.

One of virtual device example is CyMSG server. It is a mail server for the portable devices, and a gate to SMTP. It uses CyMail interface and allows the portable devices to sent plain text e-mail messages to each other as well as outside CyNet to an external e-mail address through the SMTP gate, and back from an external e-mail client to portable device. In contrast to ordinary on-line messages, CyMail messages may be stored on CyMSG server for relatively long amount of time and are delivered to the end recipient as soon as the recipient appears in the visibility area of the CyCS server nearest to the CyMSG.

Another virtual device example is CyICQ gate, which allows devices to send messages to ICQ users and receive replies back as well as track onstatus of its subscribers from ICQ contact list.

As a result, sending a message to another process an application does not worry where the addressee is located, which will be an actual delivery path, if the addressee is a device or an applied task running on server.

Address/Phone BookAddress/Phone Book is serve to store people″s contact information, Cybiko users in particular. You can receive data about those people automatically. In each record it is possible to store the following data: CyID (for Cybiko users).

Nickname First name Last name Phone E-mail ICQ AddressYou can add records in Address book manually and also you can receive contact information about another device owner via wireless connection and automatically store it in address book.

The application allows the user to add his/her contact information to another users in wireless network and also send e-mail if it is in the record. See FIG. 17.

In E-mail application gives an opportunity to choose the e-mail address from Address/Phone Book.

File ManagerThis application is to browse and manage the set of files on the minicomputer. The application may work both with one file device installed on minicomputer and with several file devices (for example, it may be built-in flash-memory block, SMC card or Memory Card with inserted cartridges).

Moreover, the application supports folder management. Practically, the application supports two different file systems its own system for working with built in flash-memory blocks and Memory Card and PC-compatible system for working with SMC card.

The application contains flexible system of file list view settings. Existing settings include different kinds of file list orderings, turning on/turning off the filters, showing information about files and folders.

The user has access to the more detailed information about each file and folder. Specific view of given information depend on chosen object.

When File Manager is started the list of available file devices is shown on the screen. After file device is chosen the application is displayed the list of available files and directories taking into account stored on the device folder”structure. The application gives the following functions of file management: renaming, deleting, copying, and cutting. Moreover, all these actions can also be made recursively on any folder with all its contents. Copying of files/folders can be made both within limits of one file device and from one file device to another. The user can create new folders, and new files (if there are special application destined for that on the device).

Files may also be sent via radio channel on other minicomputers. The user of receiving minicomputer is given with information both about name of incoming file and about name of the user”minicomputer sending this file. After he/she has an opportunity to accept or reject receiving of this file. If the user agrees to receive the file, he/she may choose with the help of File Manager the file device and folder where he/she wants to save incoming file.

The last function of application is an opportunity to start the external modules and applications stored on the minicomputer. File Manager application also checks the starting application on accuracy of its working taking into account installed software and minimal requirements needed for correct application work. Some working with user”files applications may be started when directly one of such files is run from File Manager application. In that case this file opens for viewing and/or editing in the respective application.

File Manager application also is used by other applications. For example, wireless multiplayer games have the special function to send its main module via radio channel in the case if there is no of this game on one or more user″devices which want to play it.

Wireless E-mailSends/receives e-mails from/to wireless device (Cybiko computer). To send the mails (transfer data) three different methods can be used: from one device to another by radio communication; via CYWIG; with a help of EZLoader (using Internet connected PC).

The application consists of two parts:Resident one is always started, invisible for user. Performs sending/receiving messages.

Client one is for creating new messages, viewing and deleting existing ones.

Resident part (working permanently in background mode) is both for receiving mails at any time as device is on and for sending mails at a moment when there is a real opportunity for that (device-recipient or CyWIG are found within the field of vision). As CyWIG or device-recipient are found by device within the field of its vision, resident part forms the message of special format from the record in the database containing the specific mail and then send it via radio. After resident part waits confirmation from recipient about mail receiving. Just after receiving of such confirmation the changes are made in the database record containing total information about sent mail (it is transported to the list of sent items).

As resident part receives the mail in the form of message of special format this message is decoded and put to the database that stores information about all mails available at this moment on the device. At the same time, to exclude the appearance of mails-duplicates, the check is made if the same mail is in database. For that purpose each mail has the special unique text descriptor (ID). Received mail is added to the database only there are no mails with the same ID. When the mail is received the device vibrates and emits a certain beep.

To minimize traffic the next ready for sending mail is sent only if mailing sending of the previous mail is completed.

The client part serves to create new mails, to view and delete existing ones. It is the interactive application built on the base of the window architecture. The application has several forms designed both for looking the contents of different mailboxes and single mails and for creating and sending new mails. There is an opportunity to choose required address either from e-mail list of PhoneBook application or from list of devices available via radio. Several recipients can be included to the mail in semicolon.

After the user has entered mail content, it is put down to the special database from which resident part takes the mails for sending. One of the fields in the database is descriptor of mailbox containing the mail. There are 5 of such mailboxes: New for incoming but not read mails; In for read incoming mails; Out for mails ready for sending (resident part will take the mails from here); Draft for drafts; Sent for already sent mails. When resident part has sent the mail to the recipient it just changes ID of mailbox into Sent and in that way the mail is replaced to the Sent folder.

There is an opportunity to attach to the mail any files that are stored on the device. At the same time the copy of this attached file is created in the special system folder on the device, reference to this file is created in the database. To minimize traffic mails with attached files are sent only through EZLoader program running on Internet connected PC. Receiving of the mails with attached files happens similarly.

EZ LoaderThe EZ Loader allows to transmit the files and texts in any combination between the following devices: the Cylbiko device (below is named as a device [like Classic or Xtreme]), the user”s PC and the Internet sites. The connection between the devices is realized through RS232 cable for Classic and USB cable for Xtreme. Connection with sites is realized through HTTP, SMTP and POP3 protocols.

Work with files the program allows to view the file system as a part of the PC”s file store. (through the program Explorer —the standard delivery of Microsoft Windows). There is the support of all standard options with files as copying, moving, deletion, renaming. It is also possible to change the file (folder) attributes. The file options can be applied either to separate files and the group of files and folders. Variety of options with files can be limited if set the definite attributes. Upon selecting the device in the structure of PC”s file system the items of the main menu allows to know the general information about the device″s file system as the memory space free, the number of files etc.

Downloading and setup the applications and program package The program allows to setup applications and program packages downloaded from Internet. The applications can be released on site in the form of the app file (<filename>.app) or in the form of the file archive (<archive name>.cap) containing the files and scripts, made on the languages MicrosoftJscriptor Microsoft VBScript . If it”s a single file application the program will offer to choose the devices” folder where the app file will be copied. If it”s an archive the program will find there the script install.js or install.vbs (below is named as installation script) and run it. With help of this method the package developer can program the installation program, as he wants. For example, there can be defined the version of the system package on the devise, the contents and versions of the already installed apps. There can be asked the folder to install in and known the information about the local user”s PC. Depending on the information that you will get you make the necessary options for the installation. If the achieve doesn”t contain the installation script, the program will ask the folder for the installation and copy all files in it. During the either of types of the installation the user is shown the progress bar indicating the process. All errors occurring during the installation are displayed to the user.

Synchronization this option allows the user to make the identity of data entries that are stored on the PC or on the Internet site and on the device. The data entries are: the files that are stored in the special folder(s) on PC, subscription files and e_{—mails on the site of Cybiko, Inc., contacts and tasks in program Microsoft Outlook. During the synchronization the program defines the discrepancy between the data entries and provides the three variants of further actions: change the device”s data entry to PC”s one, change the PC”s data entry to device”s one or keep as it is. Program settings allow setting variant of the action by default and making the special settings for each type of synchronization. The program also allows synchronizing the clock on the device in accordance with the time on the site what can be important when work with some programs.}

Backup/Restore the purpose of Backup option is to save the user”s settings, apps and files on the hard disk in order to restore them if they have been lost. When Backup the user can choose 1) the file types which they need to save2) the file name on PC in witch the chosen file types will be saved.

During the option the program is viewing the device”s file system and coping all files of the chosen types to the PC”s hard disk. Then, it archives all copied files in one with the name that the user chooses. All full paths to the files on the device are saved in order to restore the folders” structures on the device. When Restore, the program analyses the file types in the chosen archive (Backup file) and allows to restore either all files in the archive or the files of the types that have been chosen. Before Restore, it is possible to delete all files that are stored on the device and then restore them from the archive. If the file is in the archive and on the device there are two ways of behavior: changing the device”s file to archive”s one or keep as it is (on the device). The program settings allows to set the file types that are offered on Backup by default and output the warning about Backup or Restore.

System package update the purpose of this option is to change the OS and the set of apps that is delivered with it to the other system version (either the more new or old). The user chooses the device to update (note: there is the localization limit; the update file destined for USA”s device can”t be installed on the UK”s device) or sets that the first reloaded device will be updated. The last type of choosing the device is necessary to restore the device”s efficiency, if this has happened (battery discharge etc). After this the user are allowed to choose the type of the system”s update: light, custom and full. If it is light update, then the files (with their version numbers) on the device are updated in accordance with the OS version. When it is custom update the user can choose what files will be changed. They can also add the option of formatting the file system. If it is full update the file system is formatted then all updated files are moved on the device.

Sending statistics files to the site—Statistics files contain statistical information about number of starting of application and the best results achieved by the user. Information about the best-achieved results allows making of numerical signature certifying that the file is produced on this device. It will allow (in the aggregate with data transmitting to the server about best game results) holding contests for defining the best player. At the same time owners of devices takes the part in common rating for this game and can see total table of the records on the site. Summation of content or changes in the Table of Records on the server occurs as soon as results are received from device.

Other program settings (that are not listed above) permits the user to setup the program interface and view information about device not indicated nowhere in other place of program (for example, version of Operating System, localization etc.).

CyberLoad features:1) Transferring files and technical data between devices connected to a PC via RS232 port and the web site. CyberLoad displays a set of applications on the web site and on a device connected; users can choose applications and download them directly to the device. The list of available applications is created on the web-site (this depends on operating system version which is running on the device.)File transferring is performed using HTTP protocol.

2) Uploading files from a device connected to the web site. Every time a device is connected, a file that contains statistical data about application launching is uploaded to the web site. This file is called statistics file. It contains the number of times each application was started, and the best game scores. These results are used for estimation of application popularity.

3) Information about the best game scores can be digitally signed, thus confirming that the file was uploaded from a certain device. This feature allows conducting game contests. Best scores and ratings are shown on the web site, the information updating every time new results are received.

File uploading is performed using HTTP protocol.

4) Sending/receiving e-mail. As a device is connected, CyberLoad checks the device”s mailbox for unsent messages. These messages are sent via a mail server on the web site. Then CyberLoad checks the mail server for new e-mail messages for the device connected and downloads them to the device”s mailbox.

5) Synchronization with a mailbox. Content of device”s mailbox is synchronized with content of another mailbox, which is located on the web site”s mail server.

6) Transferring files between a PC and a device connected.

7) Updating operating system on the device connected. A new operating system is installed directly from the web site.

8) Task and contact synchronization between Microsoft Outlook and tasks/contacts on a device.

Wireless ChatMore and more hand-held devices receive the ability to communicate with each other by means of wireless network. Different approaches are used to implement this feature, and depending on them, wireless hand-held computers can be divided into two categories: Short-range wireless devices. These devices are usually able to communicate with each other within a small area. They use simple transceiver, which consumes little battery power, doesn”t require special frequencies to be unoccupied to work and its data usually is considered as noise. This allows them to work in environments where a lot of radio equipment is present. These devices are game devices, personal planner devices or small full-functional computers.

Long-range wireless devices. These devices usually utilize wide-range radio networks, such as GSM. They are usually equipped with a rather powerful transmitter that consumes more battery power, and sometimes considered harmful for human”s health. These devices are often combined with mobile phones, personal planners and other similar devices.

This document describes the implementation of the Wireless Chat application for the short-range wireless computers.

FeaturesWireless Chat application provides the following services for its users: 1.User is able to see the number and the list of people within some nearby area. User can query anyone for the information marked as public.

2.User is presented with a number of virtual rooms with some short description of each room. For example, there can be the following rooms: General (a room where people usually meet, introduce with each other, select topics to talk about and so on), Rock Music (a room dedicated solely for Rock-And-Roll Music fans) and so on. User is able to see the list of rooms, their corresponding descriptions, the number and the list of people located in that room and the policy of the room. The room”s policy includes rules for the newcomers, language style regulations, maximum number of people in the room and so forth.

3.User is given the ability to create new rooms. The user selects the room”s name, room”s description, room”s policy and optionally several other parameters such as a password. If the room is given a password, every user trying to enter the room has to provide a valid password to be allowed to enter. This feature can be used to create private rooms devoted only for a limited number of people.

4.Wireless Chat application also connects to the wider networks including Internet and gives the user access to Internet-based chat rooms. In this case, the Wireless Chat becomes an ordinary client of the Internet Chat system and plays part of the computer terminal.

5.Being in the room the user can see all broadcasted messages in the room, construct new messages and either send them to someone in the room or broadcast throughout the whole room. If the message is broadcasted, everyone in the room hearsthe message, otherwise only the addressee receives it.

6.Wireless Chat can be selected as priority application for a hand-held computer. In this case, the Wireless Chat application is incorporated into the operating system, allowing the users not currently running the application to be notified of the events occurring in virtual rooms. For example, if the User A being in room General sends a message to the User B, which is not running Wireless Chat at all, the User B is notified and invited to enter the room Generalto chat with User A.

7.Wireless Chat can also be combined with other pieces of software, such as E-Mail client. In this case, if the addressee cannot be found in the nearby vicinity, the e-mail message is scheduled to be sent to him.

ImplementationWireless Chat application can be implemented by many different ways on the target hand-held computer. The usual implementation will consists of two parts. One part will always be running resident. Its goal is to listen the ether for incoming Wireless Chat messages and sort them out. All messages addressed to the target computer will cause the user to be invited to join conversation occurring in some of the Chat rooms (if not configured otherwise) orjust directly placed into the list of received messages. The resident part also listens for broadcasted messages but processes them only if the target device is located in the same virtual room as the message”s sender.

The other part is the Wireless Chat application itself. It implements the UI, all the features described in the previous part, and the server side of the communication protocol.

As long as wireless communication protocol does usually not guarantee the success of delivery of the broadcasted message, some tricks may be used by the application. The message may be broadcasted several times and multiple copies discarded by the clients.

If the Wireless Chat communicates with the Internet chat server, one of the hand-held devices (or some form of it) is usually being connected to a PC connected to the Internet. PC plays a role of some sort of a gateway that receives message from the Internet chat server and places them to the ether. It also listens the ether for special control messages and transfers them to the Internet chat server. The Internet chat server considers PC software as a number of ordinary clients, so the nature of the clients is transparent for the server.

Friend FinderFinder resident system service. Purposes: 1 Store personal data;2.Watch other devices in radio neighborhood;3.Exchange personal data with these devices;4.Form and update device list in radio neighborhood, sort them, and grant this information to other programs with specified API;5.Find friends on some criteria;6.Form unique names of visible devices;7.lnform user about appearance of user with high rating;8.Send to other devices on demand available personal data, such as business card, photo, etc.;9.Send to other devices on demand shared programs and data files;10.Stores information about friends and ignore list;11.Spread Trusted Time (TT) to all neighbor devices.

The very main purpose of Finder is permanent searching a friend. The Friend Finder allows a user to find a friend based on the information provided by the user. The user can also specify a type of community from which to find a friend, i.e., a community of all people in the network, or specifically from a community of all females, or a community of all males. The user can also enter information about the other person, which can be used to search for a friend.

The information used for finding a friend is entered via the You & Me feature of the Wireless Entertainment System, using the keypad and the display screen on the device. The information includes user's personal profile data. These profile data form the criteria. The criteria may be entered and modified at any time the device is turned on. At the same time, the user may also enter an importance factor associated with each criterion. The criteria data include the user's nickname, birth date, age group, gender, hobby, etc. The criteria list also includes a secret field, which, e.g., can store a secret word for communicating to a specific group of people.

The portable device wirelessly communicates the criteria to other similar portable devices. Each device compares the criteria stored in its memory with that received from the communicating device. A user is then able to view a list of people who are compatible with the user based on the information specified.

Friend Finder determines the compatibility by using a unique algorithm, which in part employs weighted averaging mechanism.

According to the algorithm, each criterion used to find a friend is assigned a weight (influence) factor, W. Friend Finder currently assigns in the program the following weight factors: gender:10age:5height:1hobby1purpose1 In addition, each criterion has a user specified importance factor, D. The possible importance factors assigned to each criterion by a user are −50, −5, −1, 5, 50. This factor can be modified at any time by a user and enables a user to prioritize certain criteria over others. For example, if the user wants the gender criteria to have more effect than any other criteria in determining compatibility, the user can assign the highest importance factor of 50 while assigning lower values to other criteria.

Another factor used in the algorithm is a comparison factor, C. Similar to the weight factor and the importance factor, each criterion is also assigned this comparison factor. The value of this factor for each criterion is assigned during the run-time of the program when a user's criterion is compared with another user's criteria. The value assigned depends on the outcome of the comparison. The following lists the values assigned to the comparison factor for each criteria.

For “purpose” criteria, the comparison factor is computed as follows:There are 5 possible purposes. This purpose, e.g., can be for business, chat, romance, sport, and other. The comparison factor is assigned a value in the matrix below depending on the purpose criteria of a user and the purpose criteria of another user. For example, if user1's purpose criteria is “purpose 3” land user2's purpose criteria is “purpose 4,” the value assigned to the comparison factor for the purpose criteria is −4, as shown at column 5, row 6 of the matrix. Similarly, if user1's purpose criteria entered is “purpose 5” and user2's purpose criteria entered is “purpose 5,” the value assigned to the comparison factor for the purpose criteria is 10, as shown at column 7, row 7 of the matrix. According to the matrix, if there is a direct match between the purposes, the comparison factor is assigned a value of 10 as shown by the 10's in the diagonal from upper left to bottom right boxes of the matrix.

The three above-described factors are used to calculate a coincidence value for each criterion as follows:Coincidence value of a criteria=W of that criteria×D of that criteria×C of that criteria.

That is, the values W, D, C of a criterion are multiplied to arrive at the coincidence value for that criterion.

The coincidence values are then used in the following equation to compute the final compatibility factor:Compatibility factor=sum of all coincidence values / sum of all absolute values of coincidence.)That is, all coincidence values are summed together and divided by the sum of absolute values to arrive at the compatibility factor.

Friend Finder alerts the user by beeping sound and device vibrating that a friend has been located. When this compatibility factor is greater than 0.6, e.g. 3 hearts, Friend Finder also alerts the user by message window. The method of alert includes a beeping sound or the device vibrating. Friend Finder allows the user to view a list of the people found to be compatible using this algorithm and also displays a number of hears on the right side of the name of the people listed. One heart is displayed if the compatibility factor is between 0 and 0.3. Two hearts are displayed if the compatibility factor is between 0.3 and 0.6. Three hearts are displayed if the compatibility factor is greater than 0.6. The number of hearts in essence indicates the degree of compatibility.

In certain circumstances, the compatibility factor is assigned a value of 1 regardless of the above calculations. An example of such a circumstance is when a secret field of a user matches with a secret field of another user. In this instance, Friend Finder alerts a user of finding a friend regardless of the computed compatibility factor.

OLE_LINK1CyLandiaOLE_LANK1 Artificial Life SimulatorFor example, CyLandia can be used as interactive computer game and minicomputer can be equipped with additional feature of sending pets in the mode of wireless net game session into game CyLandia used as application on the another minicomputer taking part in wireless game session. List of the users are currently playing in the CyLandia can be shown on the user display screen. Thus user can select desired game partner.

CyLandia is a kind of “CyLandia Artificial Life Simulator” game type.

The aim of the game is to help Cy-B to live long life, tending him every day. In the game you can earn money, give birth to small Cy-Bs and many others.

One human day corresponds to one game year that consists of four game days. For synchronizing the game time on all Cybiko computers it is used a special time meter (so-called trusted time) that is synchronized with the Eastern Time. The game simulates that it is going on even if your Cybiko computer is off. The hero of the game, Cy-B, passes five periods during his life: childhood, youth, maturity, old age and death.

The state of the game is saved periodically in the file of fixed size. This file is scrambled in order to avoid its cracking.

Cy-B can do many actions: eat, drink, wash, play on PC, watch TV, clean a flat, sleep, go in for sport, read, go to work, visit friends on other Cybiko computers, communicate with other Cy-Bs. You should help him to learn these basic skills. Finally, with a good training, your Cy-B will develop his skills and will do everything himself. Cy-B will learn faster if you praise him for the right actions, when the player increases points. Cy-B can talk to you, including complaining or delighting with you. He emotionally reacts on events happened with him and around him.

Your Cy-B has genetic inclination(genotype) inherited from his parents. It means that if his parents were intelligent, then Cy-B will be likely intelligent too. But anyway you have to help him to learn.

The game starts with a definite amount of CyBucks. This is money that you may spend for things, foods, purchasing shares or for some actions. Shares of certain companies give definite discount in buying products of the same field, also they bring annual dividends. You can increase your capital trading with other Cybiko computers. All property as well as cash (capital) are taxed annually. Player should learn some economic basics.

You personage can visit Cy-Bs on other devices with CyLandia, get friends there, get married and bear children. Each Cy-B has a pocket, to which he can put any things or money and visit friends with these things in the pocket. At an early age Cy-B gets child support. In future he can get a job that corresponds his skills (strength, intellect, sociability) that are developed during the game. While Cy-B is unemployed, he gets dole.

The yearly newspaper is issued in the game, where all CyLandia events affecting economics and personage”s desires are described. The process of getting a job is also realized through the newspaper. The newspaper is refreshed from the Cybiko web site via the communication program CyberLoad. The trusted time synchronization guarantees, that all new issues will reach all Cybiko computers simultaneously.

If you treat your Cy-B badly, he can get ill and even become virus infected. In the last case infected Cy-B can infect another healthy Cy-B.

The game keeps the log of all economic events that happened within the last two game days. For instance, how much food and other things were used, sold, bought, presented or gone into the pocket. The balance for the previous year is struck.

We claim:

1. A method of wireless data exchange amongst ad-hoc mobile devices of limited range within a communications network, the network comprising a plurality of mobile units including a source mobile unit and a destination mobile unit and a plurality of wireless communication links wirelessly connecting together, the said method comprising
a special communicative protocol supporting a plurality of tasks in connection with ad-hoc network abilities (hereinafter CYRF protocol) (for the best fit) a special communicative protocol supporting a plurality of tasks on global communications (GLOBAL MESSAGING TRANSPORT) (hereinafter GMT).
a special entertainment-, e-mail- and organizer type features, based on wireless ad-hoc networks”abilities gained by said protocols, the said CYRF communicative protocol further comprising
a routing method for providing data exchange among devices in network,
a frequency division multiple access method,
an registration data broadcasting method,
RF output power control method,
fail-safe file system;
the said GLOBAL MESSAGING TRANSPORT (GMT) further comprising
special interfaces for data transfer amongst mobile devices and to/from global network;
the said special entertainment-, e-mail- and organizer type features further comprising
Friend Finder,
Wireless E-mail,
Wireless Chat,
Address/Phone Book,
EZ Loader and Cyber Load,

2. The method of claim 1 wherein a routing method of for supporting ad-hoc mobile communications within a communications network further comprising:
periodically transmitting an identifier signal by each of said plurality of mobile units in the network and receiving said identifier signals via said communication links between said mobile units;
evaluating (estimation of) the quality of said communication links between said mobile units in accordance with the time said identifier signals are being received from an associated mobile unit via said communication links;
evaluating (estimation of) the quality of signal of said communication links between said mobile units in accordance with the signal strength measured on physical layer while receiving the signal from an associated unit via said communication link;
selecting a communications route through the network from the source mobile unit to the destination mobile unit based on the quality of said communications links; and
transmitting an information signal from said source mobile unit across said network via said selected communications route to said destination mobile unit,
wherein said step of selecting a communications route comprises
transmitting broadcast query signals from the source mobile unit across the network;
appending route information to the broadcast query signals regarding the status of mobile units transmitting the broadcast query signals:
receiving and evaluating the broadcast query signals at the source mobile unit,
selecting a route through the network that was first received on source mobile unit; and
transmitting a route identifier signal along every route through the network from the destination mobile unit to the source mobile unit,
wherein the evaluating (estimation of) the quality of said communication links is processed

3. A routing method according to claim 2, wherein said communications links comprises various types of communication links, including wireless (radio frequency and infrared) and wired (LAN, serial and USB) links.

4. A routing method according to claim 2, further comprising periodically transmitting an mapping signal consisting of random set of known identifiers of associated mobile units by each of said plurality of mobile units in the network and receiving said mapping signals via said communication links between said mobile units;

5. A routing method according to claim 2, further comprising providing an associativity table at each mobile unit, each said associativity table storing regularly updated information regarding the quality of each communications link between said mobile unit and its associated mobile units.

6. A routing method according to claim 4, further comprising storing in said associativity table information regarding associated mobile units not having direct communication link to the mobile unit but with information about a mobile unit that is intermediate for the destination.

7. A routing method according to claim 2, further comprising providing information relating to the forwarding delay of each said communications link between said mobile unit and its associated mobile units.

8. A routing method according to claim 2, further comprising providing a routing table at each mobile unit, each said routing table being configurable to set a route for passing said information signal through said mobile unit from one of its said associated mobile units to others of its said associated mobile units.

9. A routing method according to claim 6, wherein each mobile unit represents a node of the communications network and each said routing table stores information regarding a source node, a destination node, an incoming associated node, an outgoing associated node and the distance of said mobile unit from the destination node and the distance of said mobile unit from the source node.

10. A routing method according to claim 2, wherein the network supports a plurality of selected routes between respective source and destination mobile units, each mobile unit in the network being able to handle a plurality of selected routes and being able to store route relaying load information regarding the total number of selected routes supported by said mobile unit.

11. A routing method according to claim 8, wherein said step of selecting communications route also comprises considering the route relaying load information stored in the mobile units.

12. A routing method according to claim 2, further comprising:
providing a seen table at each mobile unit, said seen table recording identifier data regarding an information signal which has passed through said mobile unit; and
using said seen table to recognize and discard information signals that have previously been passed through said mobile unit.

13. A routing method according to claim 2, wherein said information signal is provided in data packets, each data packet being arranged to hold routing information, control information and message information.

14. A routing method according to claim 2, further comprising providing a data flow acknowledgment mechanism comprising passive acknowledgments, each said passive acknowledgment comprising receiving at a mobile unit an information signal previously sent by the mobile unit to one of its associated mobile units and retransmitted back thereby.

15. A routing method according to claim 14, wherein said data flow acknowledgment mechanism further comprises active acknowledgments, each said active acknowledgment occurring when an information signal has reached its intended destination and retransmission would not occur passively, said active acknowledgment comprising the mobile unit receiving an active retransmission of an information signal sent by the mobile unit to its associated mobile unit acting as the destination node.

16. A routing method according to claim 14 or 15, further comprising retransmitting said previously sent signal from said mobile unit to said associated mobile unit if a passive or active acknowledgment is not received within a predetermined time out period.

17. A routing method according to claim 2, further comprising:
appending quality of service information to the broadcast query signals, the quality of service information containing criteria on route selection which are taken into account on selecting a route through the network.

18. A routing method according to claim 2, wherein said route identifier signal configures mobile units along the selected route to pass forthcoming information signals between said source mobile unit and said destination mobile unit.

19. A routing method according to claim 2, further comprising using of mapping table for sending route request directly to associated mobile device that is registered in said mapping table as an intermediate node to destination mobile device instead of broadcasting said request.

20. A routing method according to claim 2, further comprising reconstructing the selected route in response to a change in the quality of one said communication links indicating a broken communication link invalidating the selected route.

21. A routing method according to claim 20,,wherein mobile units along the selected route are configured to pass forthcoming information signals between the source mobile unit and the destination unit and said step of reconstructing the selected route comprises:
identifying a pivot mobile unit in the selected communications route adjacent the broken communication link;
transmitting a localized query signal from the pivot mobile unit across the network;
appending route information to the localized query signal regarding the status of mobile units passing the localized query signal;
receiving and evaluating the localized query signals at the destination mobile unit;
selecting a new partial route through the network from the pivot mobile unit to the destination mobile unit, the selection being based on the stability of the communications links therebetween; and
configuring mobile units along the new partial route to pass forthcoming information signals between the source mobile unit and the destination mobile unit.

22. A routing method according to claim 21, further comprising:
appending quality of service information to the localized query signal, the quality of service information containing criteria on route selection which are taken into account on selecting a route through the network.

23. A routing method according to claim 17, wherein said step of reconstructing the selected route further comprises:
reconfiguring the mobile units that were previously configured to be part of the selected route but which are not now part of the new partial route, to not be a part of the reconstructed selected route.

24. A routing method according to claim 16, wherein said step of reconstructing the selected route comprises:
transmitting broadcast query signals from the source mobile unit across the network;
appending route information to the broadcast query signals regarding the status of mobile units passing the broadcast query signals;
receiving and evaluating the broadcast query signals at the destination mobile unit;
selecting a route through the network based on the stability of the communications links between mobile units; and
transmitting a route identifier signal along the selected route through the network to the source mobile unit.

25. A routing method according to claim 24, further comprising:
appending quality of service information to the broadcast query signals, the quality of service information containing criteria on route selection which are taken into account on selecting a route through the network.

26. A routing method according to claim 16, wherein said step of reconstructing the selected route further comprises:
(a)identifying a pivot mobile unit in the selected communications route adjacent to the broken communication link;
(b)determining the distance between the identified pivot mobile unit and the destination mobile unit;
if the distance is greater than half the distance between the source mobile unit and the destination mobile unit,
transmitting a broadcast query signal from the source mobile unit across the network;
appending route information to the broadcast query signal regarding the status of mobile units passing the broadcast query signals;
receiving and evaluating the broadcast query signal at the destination mobile unit;
selecting a route through the network based on the stability of the communication links between the mobile units; and
transmitting a route identifier signal along the selected route through the network to the source mobile unit;
or otherwise:
transmitting a localized query signal from the pivot mobile unit across the network; and
appending route information to the localized query signal regarding the status of mobile units passing the localized query signal.

27. A routing method according to claim 26, wherein said step of reconstructing the selected route further comprises:
(c)determining whether the localized query signal is received by the destination mobile unit within a predetermined time period;
if the localized query signal is received by the destination mobile unit within the predetermined time period
evaluating the localized query signal at the destination mobile unit-selecting a new partial route through the network form the pivot mobile unit to the destination mobile unit, the selection being based on the stability of the communication links therebetween and
configuring mobile units along the new partial route to pass forthcoming information signals between the source mobile unit and the destination mobile unit;
or otherwise:
identifying a new pivot mobile unit in the selected communication route adjacent to the previous identified pivot mobile unit, and carrying out step (b) on the basis of the new identified pivot mobile unit.

28. A routing method according to claim 27, wherein step (c) is repeated until the destination mobile unit either receives the localized query signal or the broadcast query signal.

29. A routing method according to claim 1, wherein mobile units along the selected route are configured to pass forthcoming information signals between the source mobile unit and the destination unit, further comprising deleting the selected route when it is no longer required, said deleting step comprising transmitting a deletion signal from the source mobile unit across the network, said deletion signal reconfiguring each mobile unit in the network.

30. A routing method according to claim 2, wherein said routing method is arranged for use with fixed base station wireless local area networks as a back-up communications system in case of base station failure.

31. A routing method according to claim 2, further comprising providing means for dynamically adjusting the transmission power of mobile units in the network in heavy usage conditions such that the number of relatively lightly-used communications links of a given mobile unit can be reduced thereby increasing the throughput of said mobile unit. A routing method according to claim 2, further comprising discovering a new mobile unit and incorporating the new unit into the communication network, said incorporating step comprising:
detecting the presence of the new mobile unit to any of the mobile units of the communications network by measuring the quality of said communication links between the new mobile unit and an associated mobile unit; and establishing a communications link between the new mobile unit and its associated mobile unit.

32. A routing method according to claim 31, further comprising:
determining the services provided by the new mobile unit; and notifying the mobile units in the communications network of the discovery of the new mobile unit and of the availability of its services.

33. Method of claim 1, wherein communication devices, comprising means for data processing and RF transceiver (hereinafter radio communication means) operating within the fixed frequency band, providing the division of all or a part of said frequency band into two or more frequency channels (sub-bands), one of which is considered as base channel, and the others as operative ones, wherein all the variety of possible applications or tasks to be processed is preliminarily assigned on at least one channel, and one channel is being assigned to use for processing only account data of all the plurality of devices in network.

34. Method of data exchange amongst communication devices of claim 33, wherein every kind of application or task is being assigned among assigned channels, so that for every channel is assigned one or more type of application or task.

35. Method of data exchange amongst communication devices of claims 33, 34, wherein the job is processed by the following steps:
every device periodically broadcasts its own account data;
every device periodically collects account data about other communication devices within the accessible range on the specially assigned channel for account data exchange;
the channel assigned for this type of job is being selected and occupied; to process the joint job the devices switched to the channel where this job is currently being processed;

36. Method of data exchange amongst communication devices of claims 33-35, wherein for every radio communication mean is preliminarily assigned an identification number (ID).

37. Method of data exchange amongst communication devices of claims 33-36, wherein account data includes at least device ID plus current occupied operative channel number.

38. Method of data exchange amongst communication devices of claims 33-37, wherein for the account data storage about the surrounding devices in range, in the device”s memo is organized a special inner device list.

39. Method of data exchange amongst communication devices of claim 33, wherein if for a specific type of job is assigned more then one channel, and at least one of the channels is occupied by other application, then the next not occupied channel number in the channel-job list is selected as an operative channel.

40. Method of data exchange amongst communication devices of claims 33-39, wherein as an environment for data exchange is represented by radio-wave;

41. Method of data exchange amongst communication devices of claims 39,40, wherein data processing means are combined with RF transceiver;

42. Method of data exchange amongst communication devices of claim 37, wherein as data processing means are represented by computers.

43. Method of data exchange amongst communication devices of claim 34, wherein for every type of job is assigned at least one operative channel.

44. Method of data exchange amongst communication devices of claims 33-43, wherein for every operative channel is assigned at least one type of application.

45. Method of data exchange amongst communication devices of claims 33-44, wherein the device comprises data processing means and RF transceiver.

46. Method of data exchange amongst communication devices of claims 33-45, wherein every device periodically transfers and receives account data on the base channel.

47. Method of data exchange amongst communication devices of claims 33-46, wherein the list of currently accessible devices is periodically refreshed.

48. A method of data exchange amongst communication devices of claim 1, wherein signal output power control in adaptable peer communication network of portable mobile transceiving devices (at least two devices) combined transceiver and means for data input and/or processing, located within the operational range, comprising the next steps
at least two levels differing in output power are preliminary assigned,
quality estimation of received signal, wherein
preliminarily assigning the connection signal quality levels (RSSI) (Received Signal Strength Indicator), on the comparison with which is assumed the decision about output power changes,
quality estimation is carried out on each data receive session.

49. The method of claim 48, wherein two levels of output are assigned, differing in power mode of regular power level and mode of extra power level, higher then the said regular power level.

50. The method of claim 48 and 49, wherein preliminary assigned at least two levels for output power signal control (RSSI)—level 1 assumed as lower level of receiving signal satisfactorily quality, level 2 assumed as upper level for receiving signal.

51. The method of claim 50, wherein quality level is estimated during each data receive session.

52. The method of claim 50, wherein as an additional information on connection quality is assumed the regularity and quality level (RSSI) of receiving ping-signal (identification signal).

53. The method of claim 50, wherein additional information field is included in the heading format of receiving information block (frame), and the value of said information field indicates the necessary output power level for information exchange between communicated devices.

54. The method of claim 50, wherein accessible devices list format contains a special field for indicating the necessary output power level for communication with the device.

55. A method of claim 1, wherein for increasing fault tolerance of a file system for carriers with a limited recording operation resource consisting in making an identical format for all blocks of the carrier, reserved as accessible, each block of the carrier is given a block occupation attribute to consider it either busy of free for recording; file identifier; logical number of the file block; and the data size in the block is thus established. Meanwhile the format of the first block of the file will additionally have the file name.

56. A method of claim 55, wherein protected file system with a limited recording operations resource containing carrier blocks reserved as accessible and having identical formats storing in a particular part of each block a busy attribute for defining the block as occupied or free for record, a file identifier distinct from those of the other files, a logical number of the block of the file and the data size in the block, in which case for the first block of the file its format additionally contains its file name, and at least its creation date and access attributes.

57. A method of claim 1, wherein for expanding the coverage area for remote transmission and reception of information for networking clients equipped with a portable device combined with a limited-range radio transceiver. The ensured technical result increases the data communication efficiency between subscribers, including possibility of world-wide message exchange. wherein
to exchange messages numerous portable computer devices with limitedradio transceivers are united into a temporary network with a coverage area exceeding that of a separate portable computer device;
the portable computer device with a limited-range radio transceiver receives radio impulse signals from transceivers of other portable computers for retransmission of the message to the end user located outside the coverage area of the source of information;
sending a message, the portable computer device equipped with a multieventoperational system and with a unique identifier connected with the limited-range radio transceiver saves data which is a block of information and comprise a message, and transmit the message under the local radio network protocol in the form of impulse radio signals through the distribution environment for the reception by the transceiver of at least one other portable computer device operating under the same protocol;
at least a part of the portable computer devices called rewith limited-range radio transceivers is equipped with a corresponding network interface and software to translate the messages into a protocol of network connection with similar devices though Internet/Intranet or with the message transfer control server through Internet/lntranet;
the server accumulates data on all ordinary portable computer devices operating in the local radio network mode and on all portable computer devices switched to the remode, under the network protocol that supports requests to lookup the devices globally and to estimate the quality of connection with them;
when an application running on an ordinal portable computer device sends a message whose receiver is out of the coverage area of the device, the message is transmitted to at least one reand the sender is switched into the mode of receiving notification about the message delivery or about the impossibility to accomplish the task;
when the message arrives to the reit is directly transmitted to the addressee, in the case when the latter is inside the recoverage area, otherwise, the resends either the message or the request to lookup addressee to the server;
when the message or the lookup request arrives, the server determines the location of another rewith the best quality of connection to the addressee, and either sends the message to the found redevice or sends the addressee location data to the requestor;
when there is no data about the message addressee on the server, the sender is notified about the impossibility to deliver the message;
when the message arrives to the redevice detected by the server, it sends the message directly to the receiver through local radio network;
after the message is successfully delivered, a corresponded notification is transmitted to the sender.

58. A method of claim 1, wherein achieving the best fit of advantages of the method the several supplemental features are added to system
Friend Finder,
Wireless E-mail,
Wireless Chat,
Address/Phone Book,
EZ Loader and Cyber Load.
